(19) United States
(12) Patent Application Publication
(10) Pub. No.: US 2007/0009757 A1
(43) Pub. Date: Jan. 11, 2007

(54) Sintered sliding material, sliding member, connection device and device provided with sliding member

(76) Inventors: Takemori Takayama, Hirakata-shi (JP); Kazuo Okamura, Hirakata-shi (JP); Tetsuo Ohnishi, Hirakata-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/570,045

(22) PCT Filed: Sep. 2, 2004
(86) PCT No.: PCT/JP04/12739

§ 371 Date: Mar. 1, 2006

(30) Foreign Application Priority Data
Sep. 3, 2003 (JP) 2003-310968
Sep. 3, 2003 (JP) 2003-310969

(51) Int. Cl. C25D 5/10; B22F 3/26; B32B 15/01; G01K 5/66

(52) U.S. Cl. 428/644; 428/567; 428/548; 428/617; 428/618; 428/643

(57) ABSTRACT

A sintered sliding material, a sliding member and a connecting device capable of demonstrating excellent seizing resistance and abrasion resistance under very bad lubricating conditions such as a high-bearing stress and slow-speed sliding condition and an oscillating condition can be provided. The sintered sliding material is composed of a sintered compact containing Cu or Cu alloy in an amount of 10 to 95 wt % and a residue made of Mo principally, in which the sintered compact has a relative density of 80% or more.

### FIELD OF THE INVENTION

The present invention relates to a sintered sliding material, a sliding member, a connecting device and a device using the sliding member improved in seizing resistance and abrasion resistance for the purpose of withstanding severe sliding conditions such as a high-speed and high-temperature condition, a high-bearing stress and low-speed condition, and a high-bearing stress and high-speed condition.

### BACKGROUND OF THE INVENTION

Generally, as an available bearing with a long lubrication interval or without lubricating, an oil retaining bearing in which a Cu-based or a Fe-based porous sintered alloy retains a lubricating oil in its pores has been in practical use extensively. In such a case, the Cu-based or the Fe-based porous sintered alloy is suitably selected according to operating conditions including an oil lubricating state, a sliding speed, a sliding bearing stress and the like. For example, in a high-speed and light-load sliding condition, a bronze based oil retaining bearing is suitably used, and in a high-bearing stress and low-speed sliding condition, a Fe—C based, a Fe—Cu based or a Fe—C—Cu based oil retaining bearing is suitably used (referring to nonpatent literature 1). On the other hand, a sliding bearing made of high strength brass material or bronze material, in which graphite flakes are regularly arranged as a solid lubricant to retain a lubricating oil, has been also utilized extensively (for example, 500SP manufactured by Oiles Corporation). In addition, conventional technologies for improving sliding performance under a high-bearing stress and slow-speed sliding condition have been disclosed in patent literatures 1 to 8. Here, the nonpatent literature 1 describes on a selection of a lubricating oil used for an oil retaining bearing, for example, a high-viscosity lubricating oil is suited for an oil retaining bearing used under a low-speed and high-load sliding condition; a low-viscosity lubricating oil is suited for an oil retaining bearing used under a high-speed and light-load sliding condition. The nonpatent literature 1 further describes that a lubricating oil used for a sintered bearing is totally made to have higher viscosity than a nonporous sliding bearing because release of hydraulic pressure is small.

The patent literature 1 discloses an oil retaining bearing, made of a ferrous sintered compact, used under a sliding condition of a high bearing stress of 600 kgf/cm² or more and a sliding speed of 1.2 to 3 m/min, and further discloses a sliding bearing made such that the oil retaining bearing is impregnated with a lubricating oil having a kinetic velocity of 240 cSt to 1500 cSt. The ferrous sintered compact is preferably made such that a composite sintered alloy, which is composed of Cu powder and iron powder and has a porosity of 5 to 30% by volume, is carburized, nitrided or sulphurizing-nitrided at a sliding surface thereof.

The patent literature 2 discloses an iron based sintered alloy having an iron-carbon alloy substrate which is composed of martensite and contains at least either one of Cu particles or Cu alloy particles dispersed therein. By filling pores of the iron-carbon alloy substrate with a lubricating compound containing an extreme-pressure additive of a semisolid-state or a solid-state at a room temperature, having a dropping point of 60° C. or more, or a solid lubricant, the iron based sintered alloy will be used for a sliding bearing capable of operating under a bearing stress of 30 MPa or more.

The patent literature 3 discloses a sintered Cu alloy made such that a mixed powder of Cu alloy powder containing Ni of 5 to 30 wt %, Sn of 7 to 13 wt % and P of 0.3 to 2 wt % with Mo of 1 to 5 wt % and graphite powder of 1 to 2.5 wt % is pressure-sintered. The resultant sintered Cu alloy has self-lubricating property suitable for use in a wear plate of a pressing machine.

The patent literature 4 discloses an abrasion resistant sintered alloy for an oil retaining bearing. The abrasion resistant sintered alloy is characterized in that an iron-carbon alloy substrate having martensite contains Cu particles or Cu alloy particles dispersed therein with containing Cu in an amount of 7 to 30 wt % and further contains alloy particles having a specific composition as a harder phase than the iron-carbon alloy substrate dispersed therein in a content of 5 to 30 wt %. In addition, the abrasion resistant sintered alloy has a porosity of 8 to 30% by volume. In the abrasion resistant sintered alloy, a large amount of soft Cu particles are dispersed in the martensite phase so as to improve conformability, and the alloy particles harder than the martensite of the iron-carbon alloy substrate are dispersed therein so as to decrease a plastic strain of the substrate and also a load applied to the substrate at sliding, thereby to obtain excellent abrasion resistance under a high bearing stress. This patent literature recommends that the alloy particle includes (1) Fe-based alloy particles (high-speed steel particles) containing carbon of 0.6 to 1.7 wt %, Cr of 3 to 5 wt %, W of 1 to 20 wt % and V of 0.5 to 6 wt %, (2) Fe-based alloy particles (high-speed steel, containing Mo and Co, particles) containing carbon of 0.6 to 1.7 wt %, Cr of 3 to 5 wt %, W of 1 to 20 wt %, V of 0.5 to 6 wt % and at least either one of Mo or Co of 20 wt % or less, (3) Mo—Fe particles (ferromolybdenum) containing Mo of 55 to 70 wt %, (4) Co based alloy particles (heat resistant and abrasion resistant alloy particles for a build up spraying, KOBAMEETO manufactured by CABOT Supermetals K.K.) containing Cr of 5 to 15 wt %, Mo of 20 to 40 wt % and Si of 1 to 5 wt %.

The patent literature 5, proposed by the inventor, discloses a Cu—Al—Sn based sintered sliding material having a α+β dual phase structure containing at least a β phase dispersed therein or a β phase structure. The Cu—Al—Sn based sintered sliding material is characterized in that a hard dispersing material, such as various intermetallic compounds, and a solid lubricant, such as graphite, may be contained in the structure. This literature further discloses a sliding bearing which is made such that the Cu—Al—Sn based sintered material is combined with an inner surface of a ferrous back metal so as to maintain rigidity of the bearing and ensure forcing pressure when the sliding bearing is forced into a connecting device. The sliding bearing can be used under a severe condition of a slow speed (0.6 m/min or less) and a high bearing stress up to 1200 kgf/cm², while a conventional sliding material having an iron-carbon based alloy substrate cannot withstand such a severe condition. Because, the Cu—Al—Sn based sintered sliding material is softer than the sliding material containing martensite, according to the patent literature 4, and has excellent conformability with a counterpart (for example, a connecting pin) to a sliding surface thereof.

And, the patent literature 6 discloses a sintered sliding material which is made such that Mo of 0.5 to 5 wt % or Fe—Mo of 0.5 to 15 wt % are added to a bronze based or a lead bronze based sintered sliding material, containing Sn of 4 to 12 wt % or both of Sn of 4 to 12 wt % and Pb of 0.1 to 10 wt %, so as to obtain excellent lubricating property, good affinity with an oil, low friction coefficient and high abrasion resistance.

Generally, an oil retaining sliding bearing is rarely used under a fluid lubricating condition. Especially, under a condition of a significantly slow-speed and a high-bearing stress, release of hydraulic pressure through pores of the sintered material makes a thickness of a lubricating oil film formed on a bearing surface (a sliding surface) thin as roughness of the bearing surface or thinner, causing a boundary lubricating sliding condition accompanied with solid friction (adhesion) in many cases. For example, a sliding bearing (a bushing, a thrust bearing and the like) equipped for a connecting portion of a construction machine such as a hydraulic excavator is used under a condition of a bearing stress of 300 kgf/cm² or more and a sliding speed of 0.01 to 2 m/mim. In such a case, seizing resistance and abrasion resistance of the sliding bearing are significantly dependent on properties (composition and structure) of a material of the bearing.

And now, in the Cu based and the Fe based porous sintered alloy materials according to the nonpatent literature 1, a usable range of a conventionally used oil retaining bearing is shown in FIG. 16 (the nonpatent literature 1, P.337, FIG. 6.19 “application examples of sintered bearing”). FIG. 16 demonstrates as issue that the aforesaid Cu-based or Fe-based porous sintered alloy materials cannot be used under a condition of a significantly slow sliding speed of 0.01 to 2 m/mim and a high bearing stress of 300 kgf/cm².

In view of the aforesaid composite sintered alloy material, which is made such that a composite sintered alloy composed of Cu powder and iron powder is subjected to a surface treatment such as a carburizing treatment and a nitriding treatment, according to the patent literature 1, and the aforesaid Fe-based sintered alloy material containing an extreme-pressure additive and the like filled in its pores and having a martensite structure, according to the patent literature 2, each has a problem in which sufficient sliding performance may not be demonstrated at a significantly slow sliding speed (0.01 to 2 m/min).

And, the aforesaid sintered Cu alloy material having self lubricating property suitable for use in a wear plate of a pressing machine, according to the patent literature 3, has a problem in insufficient seizing resistance and abrasion resistance because locally metal-to-metal contacts with a counterpart often occur under a very slow-speed and high-bearing stress sliding condition in which a lubricating oil film is hardly formed. In addition, a strength of the material remarkably decreases when an addition amount of a soft solid lubricant, such as graphite and MoS₂, dispersed therein exceeds 2.5 wt %.

And, the aforesaid abrasion resistant sintered alloy for an oil retaining bearing, according to the patent literature 4, is made such that a large amount of soft Cu particles are dispersed in a martensite phase and alloy particles harder than the martensite of the substrate are also dispersed therein so as to decrease a plastic strain of the substrate and also a load applied to the substrate at sliding. However, there is a limit in dispersing the hard alloy particles (5 to 30 wt %) simultaneously with the soft Cu particles in one alloy. And, since a load applied to the substrate at sliding is concentrated in the hard alloy particles dispersed therein, an effect for improving adhesion resistant is insufficient. Besides, an addition of a large amount of alloy particles, which is harder than the martensite of the substrate and has no self-lubricating property, seriously damages the counterpart surface by adhesion abrasion and also raises a temperature of the sliding surface, thereby to cause seizing easily. Furthermore, a bearing bushing produced using the abrasion resistant sintered alloy is expensive. By the way, in order to reduce costs and improve sliding performance and maintenance property, a method, in which one of a sliding pair is formed by an inexpensive sliding material and the inexpensive sliding material is designed to have a part of a sliding performance, have been studied, however, the aforesaid problems have been still unsolved.

And, the Cu—Al—Sn based sintered sliding material, according to the patent literature 5 proposed by the inventor, is disclosed as a good bearing material capable of being used under a condition of a significantly slow sliding speed of 0.6 m/mim or less and a high bearing stress up to 1200 kgf/cm²; however, when it is coated with a Li grease containing a sulfur based extreme-pressure additive, seizing resistant critical bearing stress decreases down to about 800 kgf/cm². As a result, seizing resistance is likely to deteriorate depending on a lubricating condition subject to change by sulfur (corrosion resistance).

And, in the aforesaid techniques for improving lubricating property disclosed by the patent literatures 1 and 2, even if a sliding surface is lubricated with a high viscosity lubricating oil or a lubricating compound having a dropping point of 60° C. or more in order to improve lubricating property, metal-to-metal contacts friction under a boundary lubricating condition and adhesion accompanied with the contact friction are unavoidable. Accordingly, such techniques do not achieve sufficient sliding property under a higher bearing stress and a slower sliding speed than that of the disclosed examples.

And, when a construction machine, such as a hydraulic excavator, begins to operate at a low temperature as 0° C. or less, kinetic viscosity of a lubricating oil is so high that lubricating property demonstrated by a partial lubricating oil film, as described above, cannot be excepted and therefore remarkable adhesions will likely occur by metal-to-metal contact frictions. So, sufficient sliding performance required for a sliding bearing of a connecting device of a construction machine cannot be demonstrated.

In addition, when the aforesaid lubricant, to which a soft solid lubricant such as graphite is added, is actively employed, the solid lubricant is entered into pores of a porous oil retaining sintered bearing and blocks the porous capillaries, resulting in decreasing an effect of the retained oil in some cases. Accordingly, when a lubricating compound having a long lubricating interval and a high dropping point is used, it is desirable to avoid adding a solid lubricant, which blocks the porous capillary easily, thereto.

And, in general, a Cu alloy suitable for a bearing material is selected according to an using condition including an oil lubricating condition, a sliding speed, a sliding bearing stress and the like. For example, when used in oil, a relatively soft lead bronze ingot material (for example, LBC2 to 5) is often used. And, in a case of a sliding material for a floating bushing of a turbocharger used under a high-speed and high-temperature sliding condition and an oil lubricating condition, from a viewpoint of corrosion resistance, a free cutting brass based and a high tensile brass based alloys containing Pb are suitably used (for example, referring to the patent literature 7). In addition, in such the case, use of Al bronze based ingot materials has been also discussed (for example, referring to the patent literature 8).

And, an engine metal used under a high-bearing stress and high-sliding speed condition is equipped with a lead bronze based sintered bushing made such that an overlay layer made of a soft metal, such as Sn, is formed on a sliding surface thereof so as to improve conformability and therefore fluid lubricating property.

And, a member which constitutes a hydraulic pump/motor and also slides under a high-bearing stress and high-sliding speed condition (hereinafter referred to as a sliding member) uses a material with which lead bronze is combined by an enveloped casting method. In addition, in a case of a sliding member used under a significantly severe sliding condition, a high strength material excellent in seizing resistance and abrasion resistance, such as high strength brass, is used (for example, referring to nonpatent literature 2).

Nonetheless, in recent years, a sliding material such as the aforesaid lead bronze based material, the high strength brass based material containing lead and the bronze based material, which are suitably used for a floating bushing of a turbo charger, according to the patent literatures 7 and 8, needs improved seizing resistance and abrasion resistance under a higher-speed and a higher-temperature sliding condition as well as excellent seizing resistance, abrasion resistance and corrosion resistance even under a bad lubricating condition, for example, a condition in which a turbo charger begins to operate. However, such a material has the following disadvantages; (1) a Pb depleted layer is formed at vicinity of a sliding surface after elution of Pb (as shown in FIGS. 28A to 28C); and (2) even after a turbocharger is stopped, a bearing is heated up to about 400° C. by heat conduction from a turbine and therefore a layer, where CuS formed by a reaction with S contained in a lubricating oil and sludge are accumulated, is formed at traces of Pb with the traces leading to a sliding surface (as shown in FIGS. 29A to 29C). So, lubricating property demonstrated by Pb decreases, whereby an essential improvement in seizing resistance and durability (extending of duration of life) cannot be achieved. In addition, from an environmental viewpoint, it is not preferred to contain a large amount of Pb in the material.

And, in recent years, since a hydraulic pump/motor tends to have higher output and more compactness, sliding members constituting the pump/motor require improved seizing resistance and abrasion resistance. However, the conventionally used lead bronze based, bronze based and brass based sliding materials, according to the nonpatent literature 2, each has a problem in which strength, seizing resistance and abrasion resistance are insufficient in achieving higher output and more compactness.

And, the aforesaid sintered sliding material, according to the patent literature 6, has a sliding surface which has a bronze alloy parent phase containing Fe-55 to 70 wt % Mo (a ferromolybdenum phase) in an area ratio of 5% or less, or 15% or less to an area of the sliding surface. However, since the ferromolybdenum phase does not have sufficient lubricating property, the sliding surface is locally metal-to-metal contacted with a counterpart to cause adhesion under a very slow-speed and high-bearing stress sliding condition, such as a operating condition of the connecting device of a construction machine, or a high-temperature and high-speed sliding condition, such as an operating condition of a floating bushing of a turbocharger. As a result, adhesive abrasion proceeds whereby conformability, seizing resistance and abrasion resistance can not be achieved. In addition, this causes another problem in which hard MoFe (ferromolybdenum) particles damage a counterpart to the sliding surface remarkably. In such a case, adding Mo of 5 wt % or more is expected to improve sliding performance; while this addition decreases strength of the sintered sliding material. Furthermore, these amounts of added Pb and Mo cannot prevent adhesion caused by elution of Pb and Mo.
Patent literature 1; Japanese Patent No.2832800,
Patent literature 2; Japanese Patent Publication No.H10-246230,
Patent literature 3; Japanese Patent Examined No.H6-6725,
Patent literature 4; Japanese Patent Publication No.H8-109450,
Patent literature 5; Japanese Patent Publication No.2001-271129,
Patent literature 6; Japanese Patent Publication No.H7-166278,
Patent literature 7; Japanese Patent Examined No.H5-36486,
Patent literature 8; Japanese Patent Publication No.H5-214468,
Nonpatent literature 1; The Association of Powder Process Industry & Engineering, Japan, “Sintered Machine Parts—Design and Production—” GIJUTUSHOIN, Oct. 20, 1987, P. 327-341,
Nonpatent literature 2; The Association of Nonferrous Metal Casting, Japan, “Engineering Data Book of Cu Alloy Casting”, The Materials Process Technology Center, Jul. 30, 1988, p. 134-155.

### SUMMARY OF INVENTION

In a sliding material such as a connecting device used under sever sliding conditions such as a high-bearing stress and slow-speed sliding condition and a oscillating condition, and a sliding material used under a high-speed and high-temperature sliding condition and a high-bearing stress and high-speed sliding condition, it is important to well study various properties of the material, such as seizing resistance, adhesion resistance, low-frictional property and conformability.

Accordingly, an object of the present invention is to provide a sintered sliding material, a sliding member and a connecting device capable of demonstrating excellent seizing resistance and abrasion resistance under very bad lubricating conditions such as a high-bearing stress and slow-speed sliding condition and an oscillating condition.

Another object of the present invention is to provide a sintered sliding material, a sliding member and a device using the same capable of demonstrating excellent conformability at sliding and therefore to provide excellent seizing resistance and abrasion resistance under a high-speed and high-temperature sliding condition and a high-bearing stress and high-speed sliding condition.

To solve the aforesaid problems, the inventors have paid attention to Mo and Mo alloy phase which has the following properties; 1) Mo or Mo alloy phase has sufficient resistance against heat generated by adhesion with iron and the like and hardly forms an alloy with Fe chemically; 2) reactions with S contained in a lubricating oil and oxygen in the atmosphere easily form a film (MoS₂, MoO₃), which has excellent lubricating property, on a sliding surface; and 3) Mo or Mo alloy phase hardly damages a counterpart to a sliding surface. Theses properties lead to the fact that using a porous material made of Mo principally will provide a sliding material having excellent sliding performance. Consequentially, the inventors have accomplished the present invention based on the obtained fact.

And, in order to lower costs, maintaining the same sliding performance as that of a sintered sliding material made of Mo principally, the inventors have found out that Mo can be substituted with one or more elements of Cu, Cu alloy, Ni and Ni alloy. In this case, it becomes apparent that the Mo based sliding material can demonstrate its sliding performance when an amount of Mo to be added is 5 wt % or more, more preferably 10 wt % or more.

Accordingly, a sintered sliding material according to the present invention comprises a sintered compact containing Cu or Cu alloy in an amount of 10 to 95 wt % and a residual made of Mo principally and having a relative density of 80% or more.

A sliding member according to the present invention comprises a back metal and a sintered sliding body combined with the back metal, wherein the sintered sliding body is composed of a sintered compact containing Cu or Cu alloy in an amount of 10 to 95 wt % and a residual made of Mo principally and having a relative density of 80% or more.

In the sliding member of the present invention, the back metal may be any one of a back metal of a sliding bearing, a substrate of a bearing shaft supporting a rotating body and a substrate of a spherical bushing.

A sliding member according to the present invention comprises a sintered layer combined with a steel back metal, and,

a sliding layer formed by lining the sintered layer with at least any one of a lubricating compound, a lubricating resin and a solid lubricating composite consisting of a solid lubricant and a resin while being filled therewith,

wherein the sintered layer is combined with the steel back metal in a manner such that a mixed powder of bronze alloy, containing Sn of 5 to 20 wt %, in a content of 10 to 95 wt % and a residual made of Mo principally is dispersed in the steel back metal and sintering-bonded thereto.

And, in order to solve the aforesaid problems, the inventors have paid attention to Mo and Mo alloy phase which has the following properties; 1) Mo or Mo alloy phase has sufficient resistance against heat generated by adhesion with iron and the like and hardly forms an alloy with Fe chemically, for example, when a turbocharger is activated again with a bearing thereof heated up to about 400° C. by heat-conduction from a turbine after an operation stop; 2) reactions with S contained in a lubricating oil and oxygen in the atmosphere easily form a film (MoS₂, MoO₃), which has excellent lubricating property, on a sliding surface; and 3) Mo or Mo alloy phase hardly damages a counterpart to a sliding surface. Theses properties lead to the fact that using a Cu alloy based sintered material containing Mo particles or Mo alloy phase particles dispersed therein and a high-density sintered material made of Mo principally can provide a sliding material having excellent sliding performance. Consequentially, the inventors have accomplished the present invention based on the obtained fact.

Accordingly, a sintered sliding material according to the present invention comprises a porous sintered compact composed of Mo or Mo alloy containing at least one or more elements selected from the group consisting of Cu, Ni, Fe and Co in an amount of 10 wt % or less, wherein the porous sintered compact, having a porosity of 10 to 40% by volume, contains a lubricating oil or a lubricating compound of a lubricating oil and a wax filled in the pores thereof.

A sintered sliding material according to the present invention comprises a porous sintered compact composed of Mo or Mo alloy containing at least one or more elements selected from the group consisting of Cu, Ni, Fe and Co in an amount of 10 wt % or less, wherein the porous sintered compact, having a porosity of 10 to 40% by volume, contains a low-melting metal which is principally made of one or more elements selected from the group consisting of Pb, Sn, Bi, Zn and Sb and adjusted to have a melting point of 450° C. or less, or an alloy of the low-melting metal filled in the pores thereof.

A sintered sliding material according to the present invention comprises a bronze alloy-Mo based sintered compact which is composed of a bronze alloy phase containing Mo of 5 to 75 wt % and Sn of 5 to 20 wt % and has a relative density of 90% or more.

A sintered sliding material according to the present invention comprises a bronze alloy-Mo based sintered compact formed such that a Mo powder compact is sintered simultaneously with being infiltrated with a bronze alloy based infiltrant, wherein the bronze alloy-Mo based sintered compact contains Mo in an amount of 35 to 75 wt %.

A sliding member according to the present invention has a sintered sliding body, p wherein the sintered sliding body comprises a porous sintered compact containing Mo or Mo alloy containing at least one elements selected from the group consisting of Cu, Ni, Fe and Co in an amount of 10 wt % or less, wherein the porous sintered compact, having a porosity of 10 to 40% by volume, contains a low-melting metal which is principally made of one or more elements selected from the group consisting of Pb, Sn, Bi, Zn and Sb and adjusted to have a melting point of 450° C. or less, or an alloy of the low-melting metal filled in the pores thereof.

A sliding member according to the present invention has a sintered sliding body,

wherein the sintered sliding body comprises a bronze alloy-Mo based sintered compact which is composed of a bronze alloy phase containing Mo of 5 to 75 wt % and Sn of 5 to 20 wt % and has a relative density of 90% or more.

As described above, the present invention can provide a sintered sliding material, a sliding member and a connecting device capable of demonstrating excellent seizing resistance and abrasion resistance under bad lubricating conditions such as a high-bearing stress and slow-speed sliding condition and an oscillating condition.

In addition, another aspect of the present invention can provide a sintered sliding material, a sliding member and a device using the same capable of demonstrating excellent conformability at sliding and therefore excellent seizing resistance and abrasion resistance.

### BRIEF DESCRIPTION OF THE DRAWINGS

FIG. 1A is a perspective view showing a hydraulic shovel according to the first embodiment of the present invention and FIG. 1B is an exploded perspective view showing a bucket connecting device of the hydraulic shovel.

FIG. 2 is a cross sectional view schematically showing a structure of the bucket connecting device according to the first embodiment of the present invention.

FIG. 3A is a cross sectional view showing a structure of a bushing and FIG. 3B is a cross sectional view showing a structure of a thrust bearing.

FIG. 4 is a cross sectional view schematically showing a structure of a bucket connecting device according to the second embodiment of the present invention.

FIGS. 5 are views showing another embodiments of a connecting pin.

FIG. 6A to 6D′ are views showing another structures of the bushing according to the first embodiment of the present invention.

FIGS. 7 are views showing processes for producing various dry type double-layered bearing sliding members.

FIGS. 8 are views schematically showing a solid lubricant particle and Mo powder in a compact or a sintered compact.

FIG. 9A is a view schematically showing a structure of a crawler track assembly and FIG. 9B is a view showing a structure of an equalizer bar suspension.

FIG. 10A is a view showing a structure of a principal part of a suspension device and FIG. 10B is a view showing a structure of a principal part of a track roller assembly.

FIG. 11A is a photograph showing a cross-sectional structure of a fine Mo particle sintered compact, FIG. 11B is a photograph showing a structure of a fracture surface thereof and FIG. 11C is a photograph showing a structure of a portion promoting liquid phase sintering.

FIG. 12A is a photograph showing a structure of a infiltrating-sintered compact produced by the No.A1 compact and the infiltrant 2 and FIG. 12B is a photograph showing a structure of a infiltrating-sintered compact produced by the No.A2 compact and the infiltrant 2.

FIG. 13A is a photograph showing a structure of No.B3 (5 wt % Mo) sintered compact and FIG. 13B is a photograph showing a structure of No.B5 (15 wt % Mo) sintered compact.

FIG. 14A is a photograph showing a structure of No.A9 (50 wt % Mo) sintered compact and FIG. 14B is a photograph showing a structure of No.A10 (70 wt % Mo) sintered compact.

FIG. 15 is a view showing a bearing bushing used in a bearing test.

FIG. 16 is a view showing a usable range of a conventionally used oil retaining bearing.

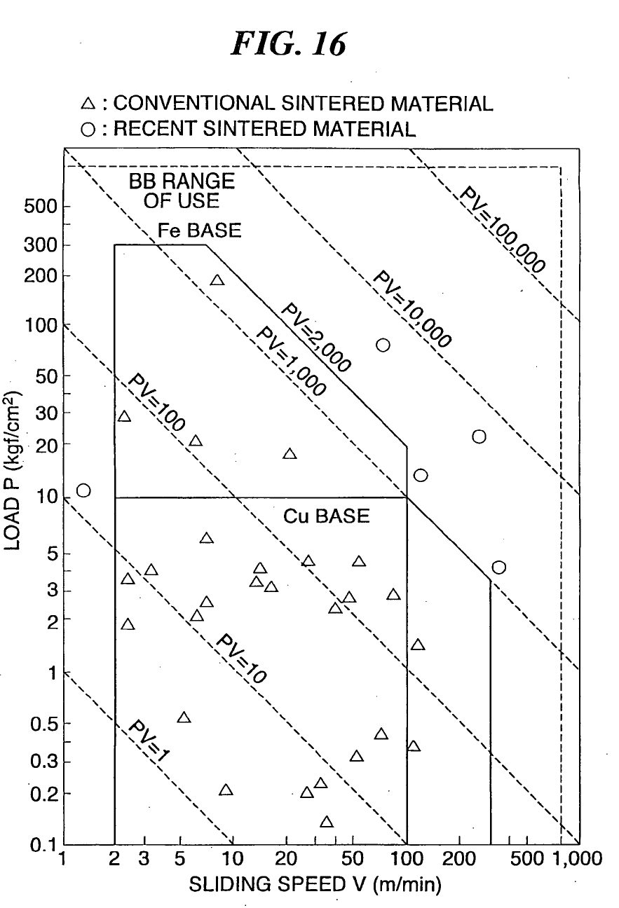

FIG. 17 is a view schematically showing a structure of a turbo charger device according to the first embodiment of the present invention.

FIGS. 18 are enlarged views showing a R part of FIG. 17.

FIGS. 19 are views showing various shapes of a sintered sliding material formed with circular holes and slits used for oil grooves.

FIG. 20 is a view schematically showing a principal part of a swash plate type hydraulic piston pump according to the fourth embodiment of the present invention.

FIG. 21A is a partial sectional side view showing a piston shoe, FIG. 21B is a cross sectional side view along P-P line of FIG. 21A and FIG. 21C is a partial sectional side view showing a piston show according to another embodiment.

FIG. 22 is a view showing a structure of a forcing and fitting type piston shoe.

FIG. 23A is a view schematically showing a principal part of a bent axis type hydraulic piston pump according to third embodiment of the present invention and FIG. 23B is an enlarged view showing a Q part of FIG. 23A.

FIGS. 24 are photographs showing fine Mo particle sintered compact, FIG. 24A is a photograph showing a cross-sectional structure thereof, FIG. 24B is a photograph showing a structure of a fracture surface thereof and FIG. 24C is a photograph showing a structure of a portion promoting liquid phase sintering.

FIGS. 25 are photographs showing a structure of a infiltrating-sintered compact, FIG. 24A is a photograph showing a structure of a infiltrating-sintered compact produced by the Mo (1) compact and the infiltrant 2 and FIG. 24B is a photograph showing a structure of a infiltrating-sintered compact produced by the Mo (2) compact and the infiltrant 2.

FIG. 26A is a photograph showing a structure of No.B4 (5 % Mo) sintered compact and FIG. 26B is a photograph showing a structure of No.B6 (15 wt % Mo) sintered compact.

FIG. 27 is view showing an abrasion test condition and a shape of a test specimen.

FIG. 28A is a photograph showing a structure of a sliding surface of a floating bushing of a conventional turbo charger, FIG. 28B is a photograph showing a Pb distribution state and FIG. 28C is a photograph showing a Fe distribution state.

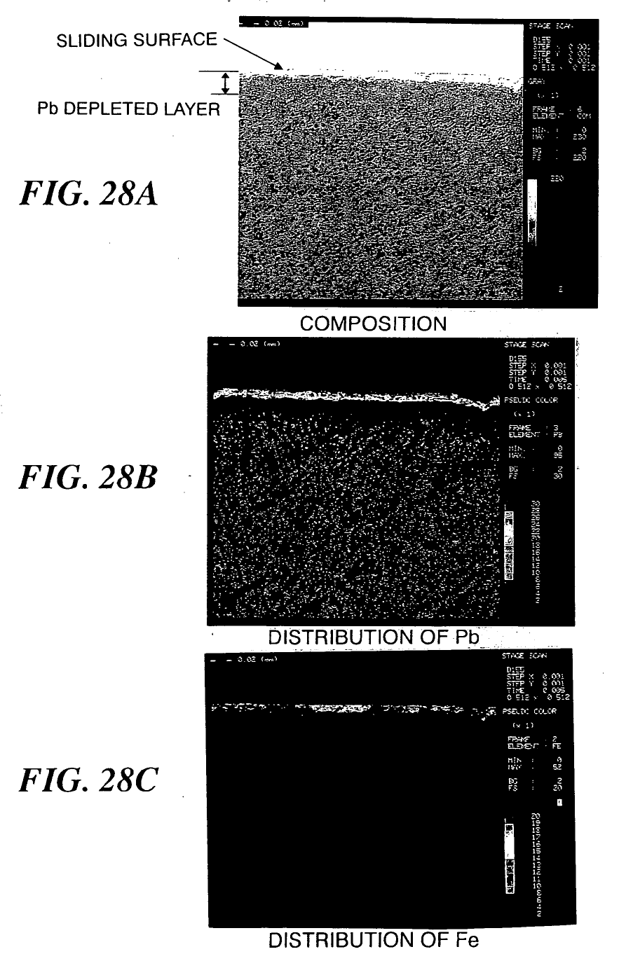

FIG. 29A is a photograph showing a structure of a sliding surface of a floating bushing of a conventional turbo charger, FIG. 29B is a photograph showing a Pb distribution state and FIG. 29C is a photograph showing a S distribution state.

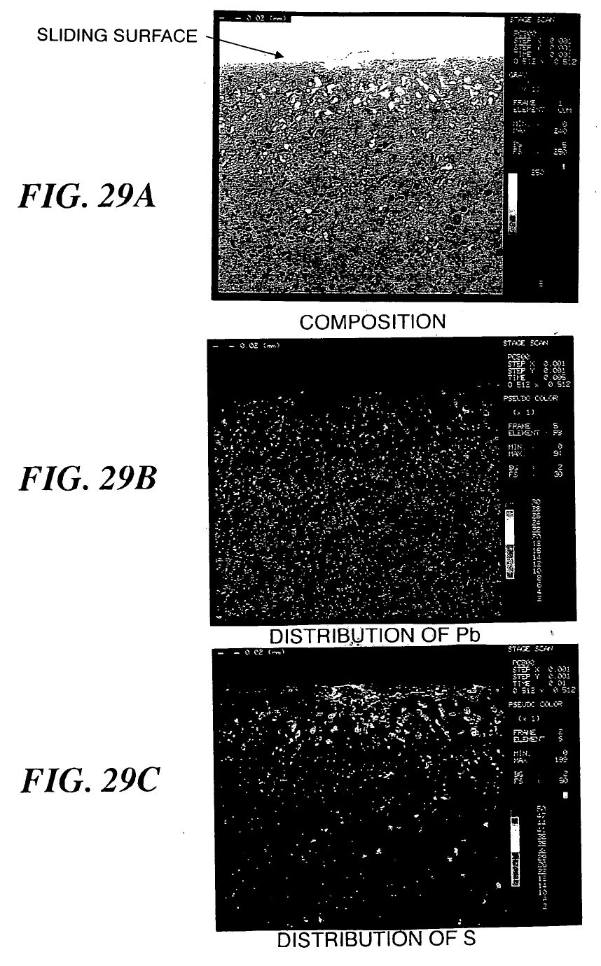

### DETAILED DESCRIPTION OF EMBODIMENT OF THE INVENTION

Next, embodiments according to the present invention will be described with reference to the accompanying drawings.

### Embodiment 1

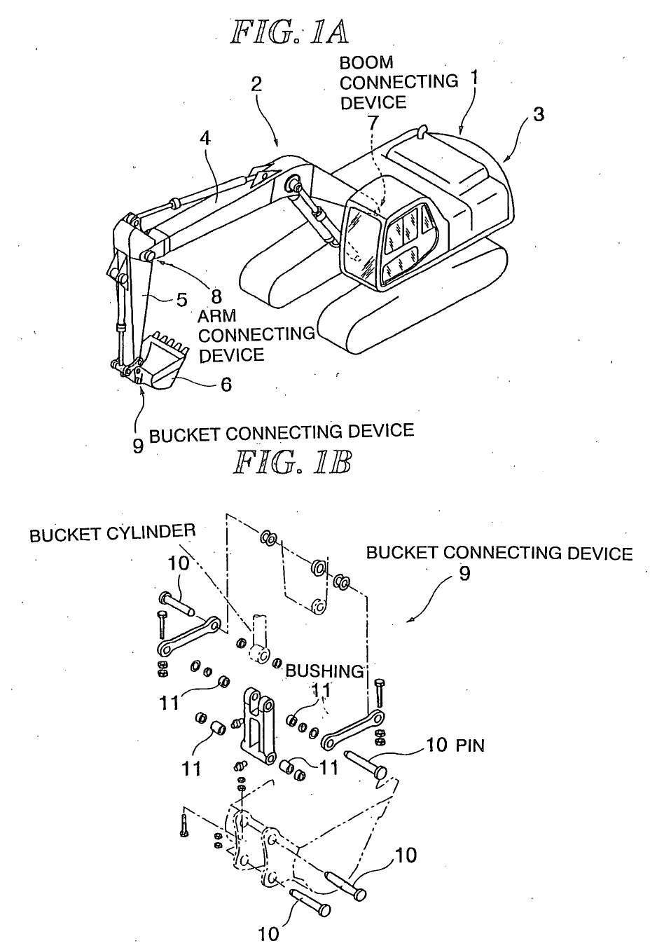

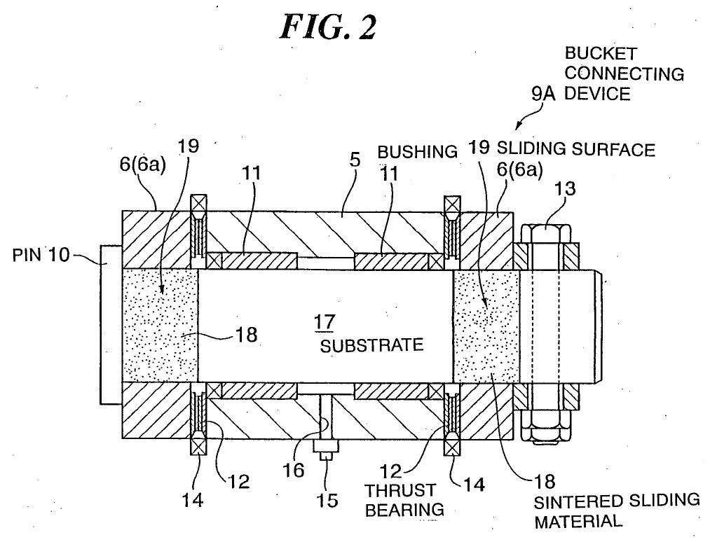

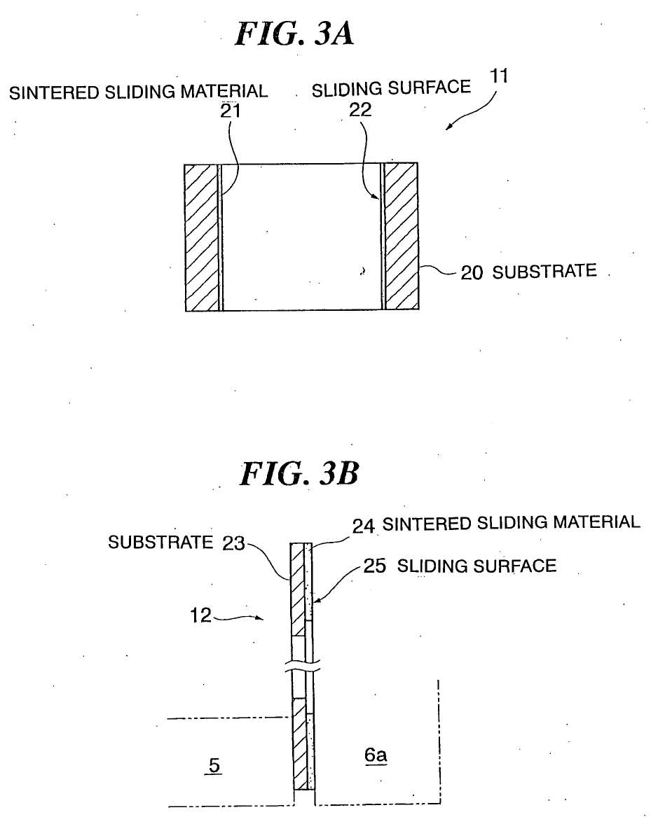

FIG. 1A is a perspective view showing a hydraulic shovel according to the first embodiment of the present invention and FIG. 1B is an exploded perspective view showing a bucket connecting device of the hydraulic shovel. FIG. 2 is a cross sectional view schematically showing a structure of the bucket connecting device according to the first embodiment of the present invention. FIG. 3A is a cross sectional view showing a structure of a bushing and FIG. 3B is a cross sectional view showing a structure of a thrust bearing.

As shown in FIG. 1A, an operating portion 2 of a hydraulic shovel 1, according to this embodiment, is provided with an upper turning body 3 to which a boom 4 is connected by a boom connecting device 7. The boom 4 is connected to an arm 5 by an arm connecting device 8, and the arm 5 is connected to a bucket 6 by a bucket connecting device 9. These connecting devices 7, 8 and 9 have the same fundamental structure. For example, the bucket connecting device 9, as shown in FIG. 1B, is provided with a connecting pin 10 and a bushing 11. Hereinafter, the bucket connecting device 9A arranged at a connecting portion of the arm 5 and the bucket 6 will be described in detail with reference to FIG. 2.

As shown in FIG. 2, the bucket connecting device 9A is provided with two thrust bearings 12 which connect the bucket (one component) 6 to an arm (the other component) 5 in a rotatable manner and receive a thrust load applied between the bucket 6 and the arm 5. Here, the arm 5 is arranged via a connecting pin (a support shaft) 10 supported by brackets 6a formed on the buckets 6 and bushings (bearing bushings) 11 fitted onto the connecting pin 10. The busing 11 is forced into a distal end of the arm 5. The connecting pin 10 is fixed to the bracket 6a by a bolt 13. A seal member 14 and a lubricating oil supply port 15, a lubricating oil supply passage 16 are shown in the figure.

The connecting pin 10 is provided with a steel substrate (a back metal) 17 functioning as an axis and sliding surfaces 19 made of a sintered sliding material 18, according to the present invention, combined with the substrate 17. The sliding surfaces 19 are formed at supported positions of the connecting pin 10 by the brackets 6a.

The bushing 11, as shown in FIG. 3A, is provided with a cylindrical substrate (a back metal (a bushing back metal)) 20 and a sliding surface 22 made of a sintered sliding material, according to the present invention, combined with an inner surface of the substrate 20. The substrate (the back metal) 20 is preferably made of a porous ferrous sintered material.

And, the thrust bearing 12, as shown in FIG. 3B, is provided with a cylindrical hollow substrate (a back metal) 23 and a sliding surface 25 made of a sintered sliding material 24, according to the present invention, combined with a surface of the substrate 23. The thrust bearing 12 is provided with an axis function for receiving a thrust load applied to the arm 5 from the bucket (a rotating body) 6 with slidable contact.

Next, the sintered sliding material will be explained in detail.

The sintered sliding material comprises a sintered compact containing Cu or Cu alloy in an amount of 10 to 95 wt % and a residual of made Mo principally and having a relative density of 80% or more. Using of the sintered sliding material makes it possible to demonstrate excellent seizing resistance and abrasion resistance under bad lubricating conditions, such as a high-bearing stress and slow-speed sliding condition and an oscillating condition. In addition, using of Cu or Cu alloy enables the sintered material to obtain both desirable sliding performance and rigidity at low costs.

And, when the sintered sliding material is sintering-bonded to a back metal made of steel or cast iron, it is preferable to add one or more elements of Al, Ti and Si.

And, since the sintered sliding material is prepared to be densified at a Cu alloy liquid-phase sintering process, a sintering-bonding method is a preferable and easy method for combining the sliding material with the back metal. Especially, in a sintered sliding body made of lead bronze alloy containing Mo of 5 wt % or more, adding Ti in a small amount improves sintering-bonding ability thereof remarkably. As a result, the sintered sliding body can be densified to have a sintered density of 8.2 gr/cm³ or more (a relative density of 90%), causing strengthening the sintered sliding material. Therefore, it becomes possible to use a cast iron containing inexpensive graphite dispersed therein as a material of the back metal.

Here, a relative density means a ratio of a density of a sintered sliding material (a sintered density) to a true density substitutable with a density of the material formed by melting.

In the sintered sliding material, the sintered compact is preferably formed such that a Mo powder compact is sintered simultaneously with being infiltrated with Cu or Cu alloy. And, the sintered compact preferably contains Mo of 35 to 75 wt % and has a porosity of 7% or less by volume.

When the sintered sliding material is made to contain a solid lubricant for increasing self-lubricating property, it is necessary to adjust a grain size of the soft solid lubricant to about 5 times a grain size of Mo powder so as to reduce concentration of stress applied on the solid lubricant and therefore improve strength thereof. For the purpose, the Mo powder compact is preferably composed of Mo powder having an average grain size of 10 μm or less and preferably contains a solid lubricant, such as graphite, MoS₂, BN and CaF₂, having an average grain size of 30 μm or more, in a content of 5 to 60% by volume. The self-lubricating property begins to be demonstrated when a content of the solid lubricant is 5% or more by volume, however, the lower limit of a content thereof is preferably set at 10% by volume for the purpose of demonstrating sufficient self-lubricating property. And, the upper limit thereof is set at 60% by volume in order to prevent the strength from being deteriorated. In order to improve abrasion resistance of the sintered sliding material, hard particles having an average grain size of 1 to 50 μm are preferably contained in a content of 0.2 to 10% by volume. In such a case, the hard particles having Vickers hardness of Hv1000 or more are necessarily prepared to have an average grain size of 10 μm or less, more preferably 5 μm or less, so as to prevent the hard particles from abrading (damaging) a counterpart.

And, the sintered sliding material is preferably combined with the back metal in such a manner that a Mo powder compact is sintered simultaneously with being infiltrated with Cu-Sn based alloy (infiltrating-bonded).

The Cu alloy phase in the sintered compact preferably contains Sn of 5 to 20 wt % and further one or more elements selected from the group consisting of Ti of 0.2 to 5 wt %, Al of 0.2 to 14 wt %, Pb of 0.2 to 15 wt %, P of 0.1 to 1.5 wt %, Zn of 0.1 to 10 wt %, Ni of 0.1 to 10 wt %, Co of 0.1 to 5 wt %, Mn of 0.1 to 10 wt % and Si of 0.1 to 3 wt %. This Cu alloy phase causes more improvement in sintering ability, infiltrating ability, sulfur resistance and strength.

The aforesaid sintered sliding material can be used under a sliding condition in which a bearing stress applied to a sliding surface is 300 kgf/cm² or more and a sliding speed is 2 m/mim or less.

In the sintered sliding material, the sliding surfaces 19, 22 and 25 thereof are preferably formed with recesses, such as holes and grooves, in which any one of a lubricating compound of a lubricating oil and a wax, a lubricating resin, a solid lubricant and a lubricating compound of a solid lubricant and a wax are filled. Theses sliding surface enable to extend a lubricating interval remarkably and also economize on material and therefore reduce cost.

While kinds of a lubricating oil to be retained in the sintered sliding material used for the bucket connecting device 9A are not limited, it is preferable to use a synthetic oil (referred as “Based and Application of Lubricating oil”, CORONA PUBLISHING CO., LTD. Seiichi Konishi, Ryo Ueda, Jan. 20, 1992, P307 to 338) having excellent heat resistance and low-temperature fluidity. In addition, when the connecting device is used under a condition in which a bearing stress is 300 to 1000 kgf/cm² and a sliding speed of 0.1 to 2.0 m/mim, a lubricating oil is preferably prepared to have a viscosity of 500 cSt or more. In this embodiment, in view of fluidity of a lubricating oil at a lower-speed sliding condition, it is necessary to satisfy the following conditions: (1) a lubricating oil has a lower viscosity and does not bring occurrences of sludge and coking at sliding so that an oil film will be formed on a sliding surface easily; and (2) even if a low-viscosity lubricating oil is used, the lubricating oil retained in the pores is prevented from flowing out therefrom excessively. In order to satisfy the conditions, it is preferable to use a synthetic oil, such as a polyol ester oil, having a low viscosity for a lubricating oil and an excellent heat resistance. In such a case, a wax (such as paraffin wax, microcrystalline wax and carnauba wax) and a metallic soap composite, such as 12-hydroxystearate, oil gelatinizing agent (for example, GP1 manufactured by Ajinomoto Co., Inc.) and lithiumstearate, in an amount of 0.5 to 20 wt % is dissolved in the synthetic oil so as to form a lubricating composite in which a lubricating oil coexists with wax in a solid-liquid state (semisolid state, gel state) at a room temperature. And, in a Mo based sliding material, as described above, it is also preferable to add a sulfur based extreme-pressure agent. Since a Mo based sliding material is excellent in seizing resistance, plain paraffin wax, polyethylene wax, various types of amidic synthetic wax and lubricating resin, such as nylon and PTFE, may be used for a lubricant.

In this embodiment, since the sliding surface 22 of the bushing 11 is formed by the sintered sliding material according to the present invention, the connecting device can be suitably used under severe lubricating conditions, such as a high-bearing stress and slow-speed sliding condition. And, the substrate (the back metal) 20 of the bushing 11 is formed by a porous ferrous sintered material capable of retaining a large amount of lubricating oil or lubricating compound, whereby the sliding surface 22 can be stably lubricated with a lubricating oil for a long term, therefore a lubricating interval can be extended remarkably. In addition, the connecting pin 10 is formed with the sliding surface 19 made by the sintered sliding material, according to the present invention, at supported portions thereof. Accordingly, even if the connecting pin 10 is applied with a large load and therefore abraded with the brackets 6a at the supported portions by turning-micromotion and flexure thereof, generation of abnormal noise can be prevented.

In this embodiment, the sintered sliding material 18 to be combined with the connecting pin 10 may be either one of a porous material or a high-density material, however, in order to further improve abrasion resistance, the sintered material preferably has a high density (a relative density of 90% or more). Furthermore, the sintered sliding material preferably contains hard particles, such as carbides of one or more elements of W, Ti, Cr, Mo and V, Fe₃P (phosphor iron compound), NiAl and CaF₂, dispersed therein.

And, the connecting pin 10 often requires to be strengthened by a heat treatment, such as an induction quenching and tempering treatment and a carburizing quenching and tempering treatment. And, when the sintered sliding material 18 is hardened, adhesion between the material 18 and the substrate 17 may become bad. In such a case, it is preferable to form a base sintered layer made of bronze based sintered material on the substrate 17 previously.

### Embodiment 2

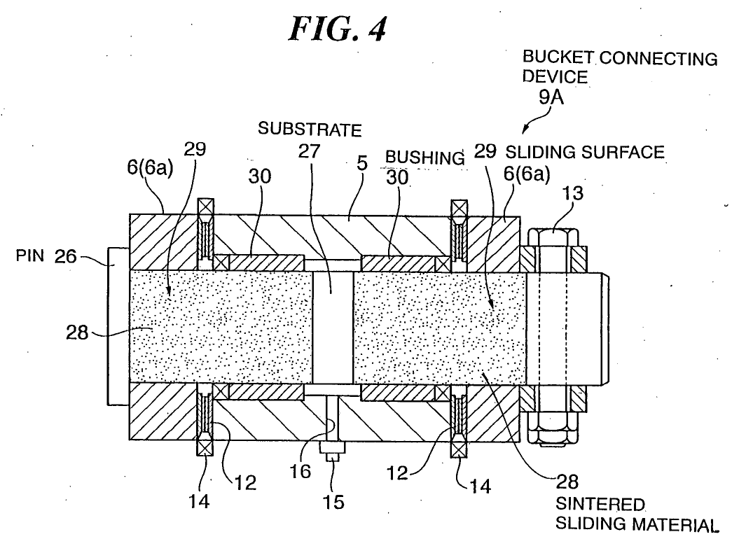

FIG. 4 is a cross sectional view schematically showing a structure of a bucket connecting device according to the second embodiment of the present invention. The bucket connecting device 9B has the same basic structure as that of the first embodiment except for structures of a connecting pin and a bushing. Hereinafter, only the specific structures in this embodiment will be explained, and the parts common to the first embodiment are represented with the same number as the first embodiment and description thereof is omitted.

A connecting pin 26, in this embodiment, is provided with a steel substrate (a back metal) 27 functioning as an axis and sliding surfaces 29 which is made of a sintered sliding material 28, according to the present invention, combined with the substrate 27. In the connecting pin 26, the sliding surfaces 29 are formed at portions where the connecting pin 26 is sliding-contacted with the brackets 6a and the bushings 30.

The bushing 30 is composed of a hard ferrous sintered oil retaining bearing material principally. And, at least an inner sliding surface layer of the bushing 30 is composed of a porous Fe—C based, a porous Fe—C—Cu based or a porous Cu—Sn based alloy sintered sliding material, with the sintered sliding material containing a lubricating compound, such as a lubricating oil, filled in the pores thereof.

In this embodiment, since the connecting pin 26 is designed to have a part of the sliding performance, a relatively inexpensive bushing can be used as the bushing 30 which is slid with respect to the connecting pin 26, thereby keeping cost low.

And, since the bushing 30 is composed of an oil retaining sintered material capable of retaining a large amount of a lubricating oil or a lubricating compound, the sliding surfaces 29 can be stably lubricated with a lubricating oil for a long term, allowing extending a lubricating interval remarkably.

In addition, in this embodiment, the connecting pin 26, which is designed to have a part of the sliding performance, is detachable easier than the bushing 30. Accordingly, when the sliding performance of the connecting device may deteriorate, the connecting pin 26 can be easily changed with a new one or can be repaired by filling abraded portions of the pin with the sintered sliding material 26, whereby it becomes possible to recover the sliding performance easily and also improve ease of maintenance remarkably. In addition, the bushing 30 in this embodiment may be composed of a conventional used porous sliding material excellent in seizing resistance.

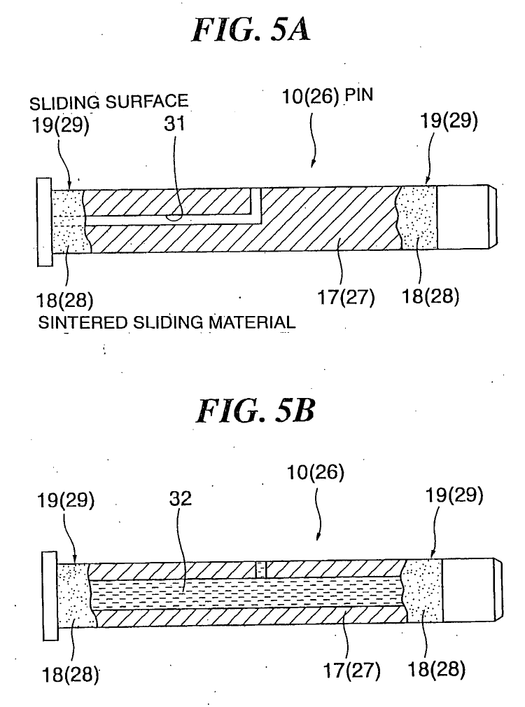

The connecting pins 10 and 26, according to the first and second embodiments, are preferably formed with a lubricating oil supplying pass 31, as shown in FIG. 5A, or a lubricating oil retaining recess 32, as shown in FIG. 5B, from viewpoints of reducing the weight thereof and maintaining the lubricating property for a long term.

In the first and second embodiments, a method for combining the sintered siding materials 18, 21, 24 and 28 with to the substrates 17, 20, 23 and 27, respectively, includes calking, forcing, fitting, clinching coupling, sintering-bonding, sintering-infiltrating-bonding, adhesion, bolt tightening and brazing.

The connecting pins 10 and 26 often requires to be strengthened by a heat-treatment, such as an induction quenching and tempering treatment or a carburizing quenching and tempering treatment. When the heat-treated substrates 17 and 27 are combined with the sintered sliding materials 18 and 28, respectively, the substrates are preferably combined with the materials by performing calking, forcing, fitting, clinching, adhesion, bolt tightening and brazing in view of preventing deterioration in strength.

On the contrary, when the connecting pins 10 and 26 are heat-treated after the sintered sliding materials 18 and 28 are combined with the substrates 17 and 27, respectively, the sintered sliding materials are preferably combined with the substrates by performing sintering-bonding, filtrating-bonding and brazing. And, more preferably, after combining the sintered sliding material with the substrate by performing sintering-bonding, infiltrating-bonding and brazing during the heat-treatment process, a quenching treatment is performed with a temperature lowered to an adequate temperature within Al temperature to 900° C.

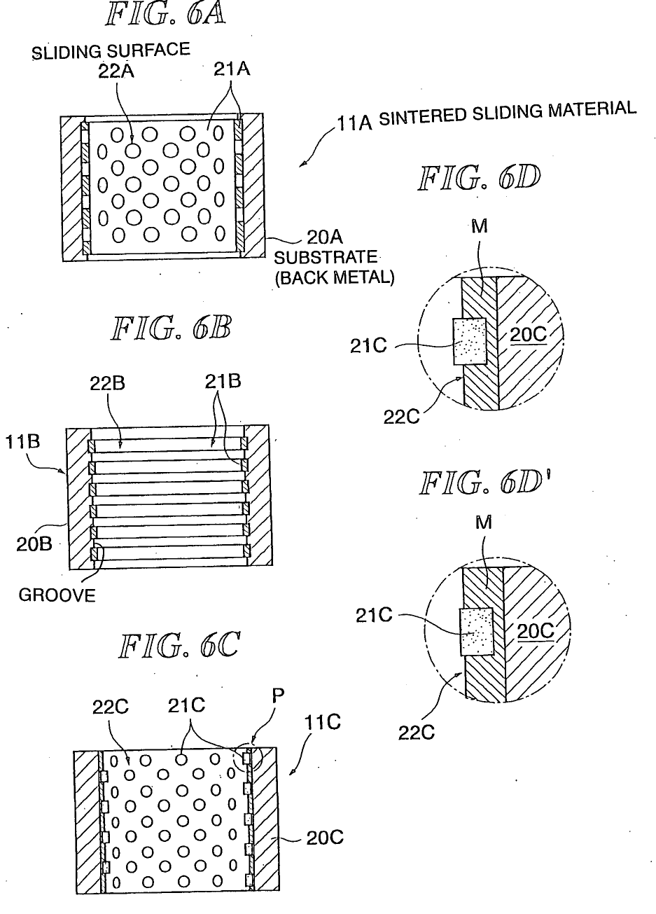

In order to increase yield of the sintered sliding materials 18, 21, 24 and 28, a punched plate (shown in FIG. 6A) is preferably combined therewith, in which case an area of a portion in which the punched plate is combined with each of the connecting pins 10 and 26 is preferably optimized according to a bearing stress applied to the connecting pins 10 and 26. And, a suitable method for producing a thin cylindrical compacts, which is formed by using Mo principally when each of the sintered sliding materials 18, 21, 24 and 28 is produced, based on the fact that the thin cylindrical compact is made fine Mo powder (as described later), includes a method for press-forming a granulated powder formed by adding an organic lubricant in an amount of 2 to 8 wt % to a precursor powder, a method for injection-forming or press-forming a kneaded powder formed by adding an organic lubricant in an amount of 6 to 12 wt % to a precursor powder and an amalgamation method for forming Mo powder dispersed in a liquid medium.

The sliding surface layers of the connecting pins 10 and 26 may be made of either one of a porous material or a high-density material. When the connecting pins 10 and 26 are made to have a double layer structure, thickening the surface layer often causes disadvantages. So, in order to improve abrasion resistance, the sintered sliding materials 18 and 28 is preferably made of a high-density material having a relative density of 90% or more. In such a case, the sintered sliding materials 18 and 28 are preferably composed of a Mo—Cu alloy based sintered material containing Mo in an amount of 10 to 80 wt % or a sintered material made of a Mo sintered compact is infiltrated with Cu alloy from an economical viewpoint. And, in order to improve abrasion resistance, the sintered sliding materials are preferably composed of a sintered material containing hard particles, such as Fe₃P (phosphor iron compound), TiC, NiAl, W and CaF₂, dispersed therein. A commercially available high-density and high-grade Mo sintered material (plate) may be also combined with the connecting pins using the aforesaid combining method, however, the sintered sliding material improved in abrasion resistance is more preferable.

If a conventional steel bushing which has an inner surface hardened by a heat-treatment and formed with a grease lubrication groove is used for the bushing 30, a lubricating interval can be extended. However, in order to more extend the lubricating interval and improve seizing resistant bearing stress, an inner sliding surface of the bushing 30 is preferably made of at least a porous sintered sliding material containing a lubricating compound, such as a lubricating oil, filled in the pores thereof. In such a case, from an economical viewpoint, a body of the bushing 30 is preferably made of a ferrous sintered oil retaining bearing material in which a hard martensite phase is formed.

In the bushing 11, the reason that the sintered sliding material 21 is combined with the cylindrical substrate (the back metal) 20, as shown in FIG. 3A, is that when the bushing 11 is used while being forced into the distal end of the arm 5, the bushing 11 requires a predetermined rigidity enough to have a sufficient gripping force for preventing the bushing 11 from slipping out of the arm 5. The practically used bushing 11 requires a thick wall having a thickness of 5 to 15 mm. So, when the whole of the bushing is made of the sintered sliding material 21, the material cost increases remarkably. Accordingly, in the viewpoint of rigidity and economical efficiency, the bushing 11 is preferably made such that the sintered sliding material 21 is combined with the inner surface of the cylindrical or approximately cylindrical steel back metal (the substrate) 20.

In a case in which the sintered sliding materials 18, 21, 24 and 28 are formed using a sintered compact composed of fine Mo powder (10 μm or less), pores formed in the sintered compact becomes to have a fine size of at least 3 μm or less. As a result, a larger permeation force of a lubricating oil permeated into the pores than conventional ferrous sintered oil retaining bearing material can be obtained, whereby a flowed out amount of the lubricating oil can decrease (about ⅕ times the conventional flowed out amount) and therefore a lubricating interval can be extended. In such a case, when it is necessary to adjust the porosity to be 10 to 40% by volume while strength thereof being maintained, it is preferable to add fine Mo oxide or fine Cu, Ni, Co, Ti, Pb, Sn or Si powder in an amount of 10 wt % or less so as to regulate the sintered density and the strength of the sintered material.

FIG. 6A to 6D′ are views showing another structures of the bushing according to the first embodiment of the present invention. In the FIG. 6A to 6D′, the same part as the bushing 11 of the first embodiment are represented by the same number as the first embodiment.

A method for increasing an amount of an oil or a lubricating compound retained in the bushing by an inexpensive way, except for a method in which a substrate (a back metal) 20 is made of a porous ferrous sintered sliding material like the bushing 11 according to the first embodiment, includes a method for combining a sintered sliding material with a steel back metal so as to form recesses, such as holes and grooves, on a sliding surface thereof so that a lubricating compound can be retained therein (shown in FIG. 6A and 6B), and a method for dispersing small pieces made of a sintered sliding material in a porous Cu based sintered material and combining the porous Cu based sintered material with a steel back metal (shown in FIG. 6C). In a case of the later method, a bushing 22c is preferably produced in such a manner that small pieces made of a sintered sliding material 21C are dispersed in a porous Cu based sintered material M while keeping from directly bonding with a back metal 20C (shown in FIG. 6D and FIG. 6D′ showing a P-part of the FIG. 6C) and then the porous Cu based sintered material M is sintering-bonded to the back metal 20c so as to form a double sintered material. Then, the double sintered material is subjected to a curling bushing producing method in which the double sintered material is roundly bended with the sintered layer being inside. Such the method enables producing the bushing inexpensively. A double layered connecting pin, in which a curling bushing made by the same curling bushing producing method, except that the double sintered material is roundly bended with the sintered layer being outside, is combined with a connecting pin by the aforesaid combining method, can be used as with the connecting pins 10 and 26.

A bushing 11A, shown in FIG. 6A, is made such that a punched plate made of a sintered sliding material 21A, like a punching metal, is roundly bended and then the bended plate is forced into an inner bore of a steel back metal 20A while butting or clinching so as to be fitted into a groove formed on an inner surface of the steel back metal 20A.

A bushing 11B, shown in FIG. 6B, is made such that a plurality of ring-shaped sintered sliding materials 21B are butted and fitted into a plurality of grooves formed on an inner surface of a steel back metal 20B. And, in the bushings 11A and 11B, a lubricating compound, such as grease, is retained in recesses, such as holes and grooves, formed on the sliding surface so that the sliding surface can be well lubricated with the lubricating compound.

And, a bushing 11C, shown in FIG. 6C, is made in a manner described below. After a Cu based sintered powder is dispersed on a steel plate, which becomes a steel back metal 20C at finishing, and then sintering-bonded thereto, small pieces 21C made of a sintered sliding material and a Cu based sintered powder are dispersed and re-sintered thereto (M in the figure; the Cu based sintered material), and then the steel is rolled so as to produce a double layered sintered member. Alternatively, after a Cu based sintered powder are dispersed on a steel plate, which becomes a steel back metal 20C at finishing, and sintering-bonded thereto, small pieces made of a sintered sliding material 21C or a Mo—Cu alloy compact, according to the present invention, are sintering-bonded thereto. And, a raw powder of a porous bronze based sintered layer M is dispersed on the steel plate, and then the steel plate is rolled and sintered so as to produce a double layered sliding member. Then, each of the double layered sliding members is roundly bended so as to produce the bushing. In the such produced bushing 11C, since the Cu based sliding material M surrounding the small pieces is made of the porous sliding material having a high oil-retaining capacity, a lubricating interval can be further extended. And, in such a case, an area ratio of the dispersed small pieces to a sliding surface of the bushing 11C is preferably 10 to 70%.

In addition, the small pieces may be made such that a commercially available high-density and high-purity Mo sintered material is crushed into chips, a compact made of Mo principally is infiltrating-sintered with Cu or Cu alloy and then crushed into chips, and a Mo—Cu based alloy sintered sliding material containing Mo of 10 to 80 wt % is crushed into chips.

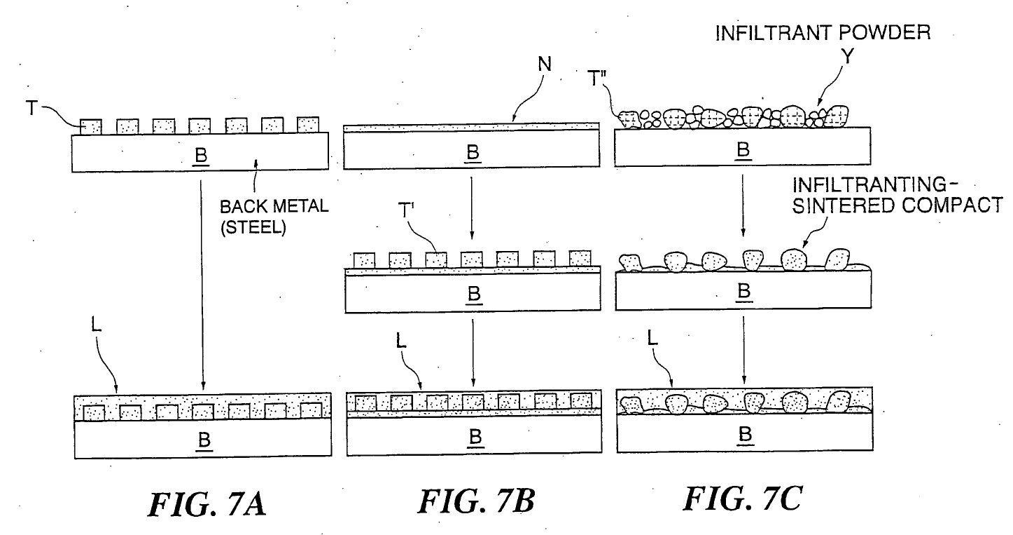

And, it is also possible to use an oilless dry bushing made such that a dry-type double layered sliding member made by each process shown in FIG. 7A to FIG. 7C is roundly bended, in exchange for the bushing 11. The dry-type double layered sliding material made by each process shown in FIG. 7A to FIG. 7C is made such that small pieces (T, T′ and T″) of compact, granular, sintered compact of a high-density Mo based or a Mo—Cu alloy based sliding material are dispersed on a steel plate B and then sintering-bonded thereto or infiltrating-sintered thereto. Then, the steel plate B is lined with a lubricating resin or a lubricating compound (solid lubricant+resin), represented by L in the figure, such that the lubricating resin or the lubricating compound is filled in the bonded layer.

In the method shown in FIG. 7A, small pieces T of a Mo—Cu alloy based compact, granular or sintered compact are directly sintering-bonded to a steel back metal B and then a lining treatment is performed.

In the method shown in FIG. 7B, firstly, a steel back metal B having a sintered substrate layer N to which a bronze based, a lead-bronze based, a Fe—Cu—Sn based or a Fe—Cu—Sn—Pb based sintered material is dispersed and sintering-bonded, is prepared. And, small pieces T′ of a high-density Mo based or a Mo—Cu alloy based sintered compact or compact are dispersed on the sintered substrate layer N and sintering-bonded to the steel back metal B via the sintered substrate layer N and then a lining treatment is performed.

In the method shown in FIG. 7C, small pieces T″ of a Mo based compact, granular or sintered compact and a Cu based powder Y as an infiltration agent are dispersed on a steel back metal B and then bonded simultaneously with being infiltrating-sintered thereto. Then, a lining treatment is performed.

In addition, it is possible to produce a bushing and a connecting pin in such a manner that a compact formed by mixing a fine Mo powder having a diameter of about ⅕ times the diameter of a soft solid lubricant granular particle, such as graphite and MoS₂, with the granular solid lubricant is sintered simultaneously with being infiltrated so as to produce a high-density and high-strength Mo—Cu alloy-solid lubricant based sliding material. And then, the high-density and high-strength Mo—Cu alloy-solid lubricant based sliding material is combined with a back metal (a back metal of a bearing, a substrate of an axis baking). The bushing and the connecting pin thus produced can be equipped for a connecting device according to the aforesaid embodiments. Operation without lubricating may be accomplished by this device. And, such the infiltrating-sintered sliding material may contain a hard solid lubricant, such as CaF₂ and Mo oxide.

And, in the first and second embodiments, the thrust bearing 12 is preferably made such that a Mo—Cu alloy based material is infiltrating-sintering-bonded or sintering-bonded to a hollow disc-shaped steel back metal (a substrate) 23 so as to form a sliding surface. In such a thrust bearing 12, it is preferable to disperse hard particles of carbide, nitride or oxide, such as TiC, TiN, WC, Fe—Mo, Fe—Cr, Si₃N₄, in the sliding surface layer for the purpose of improvement in abrasion resistance. And, the thrust bearing 12 may be used with the sliding surface layer being combined with the both sides of the steel back metal (the substrate) 23.

A sliding material according to the present invention comprises:

a sintered layer combined with a steel back metal; and

a sliding surface layer formed by lining the sintered layer with at least one of a lubricating compound, a lubricating resin and a solid lubricating composite material consisting of a solid lubricant and a resin while being filled therewith,

wherein the sintered layer is combined such that a mixed powder of a bronze alloy, containing Sn of 5 to 20 wt %, in an amount of 10 to 95 wt % and a residue made of Mo principally is dispersed on and sintering-bonded to the steel back metal.

And, the sliding material is formed by bending (the steel back metal), with the sliding surface layer being inside or outside, into a cylindrical shape or an approximately cylindrical shape.

A producing method of a sliding material comprises the steps of:

a step for dispersing a mixed powder of a bronze alloy, containing Sn of 5 to 20 wt %, in an amount of 10 to 95 wt % and a residue made of Mo principally on a steel back metal and sintering-bonded thereto so as to form a sintered layer;

a step for lining the sintered layer with at least one of a lubricating compound, a lubricating resin and a solid lubricating composite material consisting of a solid lubricant and a resin while being filled therewith so as to form a sliding surface layer; and

a step for bending the steel back metal, with the sliding surface layer being inside or outside, to form into a cylindrical shape or an approximately cylindrical shape.

And, in the steel back metal, a surface subjected to a sintering-bonding is preferably pretreated by plating the surface with Cu or by sintering-bonding with a bronze based, a lead bronze based, a Fe—Cu—Sn based or a Fe—Cu—Sn—Pb based sintered material to the surface. This steel back metal allows improving sintering-bonding ability and infiltrating-bonding ability and also preventing the small pieces of the sintered sliding material from peeling from the bonded surface when the steel back metal is formed by roundly bending into a cylindrical shape or an approximately cylindrical shape.

Here, the mixed powder to be dispersed on the steel back metal is preferably prepared such that a precursor powder, to which a binder, such as organic binder, in an amount of about 2 to 8 wt % is added, is granulated to have an average grain size of 0.05 to 2 mm. The granulated mixed powder is easily infiltrating-sintered to the steel back metal by mixing the granulated mixed powder with an infiltration alloy powder and performing dispersing and sintering. In such a case, the granulated mixed powder is not necessarily infiltrated with all of the infiltration alloy powder. And, the infiltration alloy powder remaining dispersed therein can increase bonding ability of the sliding surface layer.

A double layered sliding material like the sliding material, formed according to the aforesaid producing method, includes a dry-type bushing (for example, FB209B, FB210A, FB220A and FB410 manufactured by Taiho Kogyo co., Ltd.). Such dry-type bushing is made such that a steel back metal is lined with a lubricating resin (for example, PTFE) while lead bronze particles, which are sintering-bonded to the steel back metal with a low density, being enveloped with the lubricating resin. In the double layered sliding material, for the lubricating lining material, it is possible to use the lubricating lining material used in the aforesaid producing method of a sliding material.

Alternatively, using a porous Cu based sintered sliding material, in exchange for the lubricating lining material according to the aforesaid producing method, can also extend a lubricating interval.

Accordingly, a sliding member according to the present invention comprises:

a sintered layer combined with a steel back metal,

small pieces of a sintered sliding material, the small pieces being dispersed in the sintered layer, and

a bronze based sintered compact disposed around the small pieces,

wherein the sintered layer is made such that a bronze based, a lead bronze based, a Fe—Cu—Sn based or a Fe—Cu—Sn—Pb based sintered material is sintering-bonded to the steel back metal,

the small pieces are combined with the steel back metal with being enveloped with the bronze based sintered compact, and

the sintered sliding material is composed of a sintered compact containing Cu or Cu alloy in an amount of 10 to 95 wt % and a residue made of Mo principally and having a relative density of 90% or more.

A producing method of the sliding material comprises the steps of:

a step for sintering-bonding a bronze based, a lead bronze based, a Fe—Cu—Sn based or a Fe—Cu—Sn—Pb based sintered material to a steel back metal so as to form a sintered layer;

a step for dispersing small pieces of a sintered material to the sintered layer while a bronze based sintered compact being disposed and embedded around the small pieces, and

a step for combining the small pieces with the steel back metal such that the small pieces with being enveloped in the bronze based sintered compact,

wherein the sintered sliding material is composed of a sintered compact containing Cu or Cu alloy in an amount of 10 to 95 wt % and a residue made of Mo principally and having a relative density of 90% or more.

The sintered compact is preferably formed such that a Mo compact is sintered simultaneously with being infiltrated with Cu or Cu alloy. And, the sintered compact preferably contains Mo in an amount of 35 to 75 wt % and have a porosity of 7% or less by volume.

And, the Mo compact is preferably composed of a Mo powder having an average grain size of 10 μm or less and contains a solid lubricant, having an average grain size of 30 μm or more, in a content of 5 to 60% by volume and/or hard particles in a content of 0.2 to 10% by volume.

The Cu alloy phase in the sintered compact preferably contains Sn of 5 to 20 wt % and one or more elements selected from the group consisting Ti of 0.2 to 5 wt %, Al of 0.2 to 14 wt %, Pb of 0.2 to 15 wt %, P of 0.1 to 1.5 wt %, Zn of 0.1 to 10 wt %, Ni of 0.1 to 10 wt %, Co of 0.1 to 5 wt %, Mn of 0.1 to 10 wt % and Si of 0.1 to 3 wt %. This Cu alloy phase can further improve sintering ability, infiltrating ability, sulfur resistance and strength. In such a case, the aforesaid all elements such as Al, Pb, P, Ni and Si are not necessarily added. For example, based on the fact that P of 0.1 wt % or more improves flowability, reducing ability and wettability, the lower limit of addition amount of P, Zn, Ni, Co, Mn or Si is preferably set at 0.1 wt %.

And, in order to improve abrasion resistance of the sintered sliding material, hard particles having an average grain size of 1 to 50 μm is preferably contained therein in a content of 0.2 to 10% by volume.

The aforesaid sliding member can be used under a sliding condition in which a bearing stress applied to a sliding surface thereof is 300 kgf/cm² or more and a sliding speed is 2 m/mim or less.

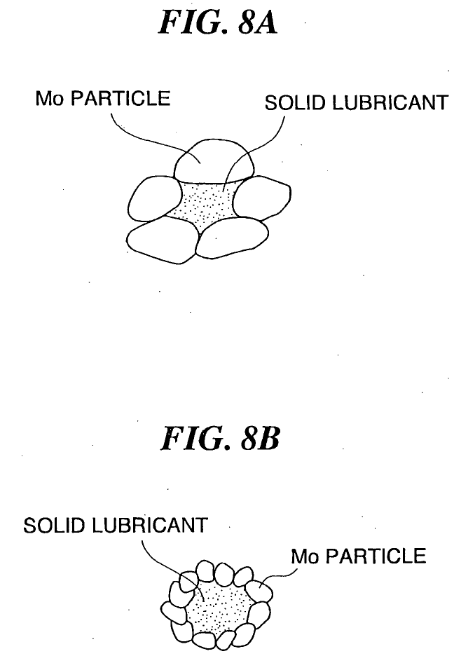

FIGS. 8 are views schematically showing a solid lubricant particle and Mo powder in a compact or a sintered compact. The figures show a relation between a grain size of the Mo powder and a size of the solid lubricant.

As shown in FIG. 8, as a grain size of the Mo powder becomes smaller, the solid lubricant is formed to be rounded, resulting in enhancing an effect in preventing concentration of internal stress and therefore preventing decrease of the strength. Accordingly, by using a Mo powder having a fine grain size as a raw material of a sintered compact, a large amount of solid lubricant can be added to the sintered compact. And, when a compacting pressure applied to a precursor mixed powder, containing a large amount of organic lubricant added thereto, is kept as small as 0.5 to 2 ton/cm², anisotropic deformation of the soft solid lubricant hardly occurs, thereby to prevent decrease of the strength. In addition, an infiltration with Cu alloy based material allows preventing concentration of internal stress.

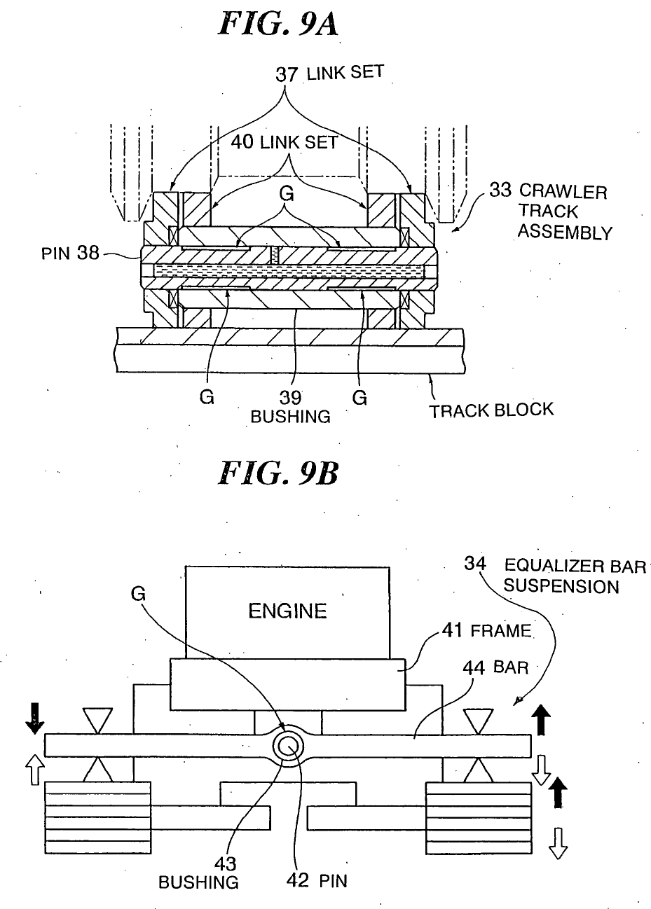

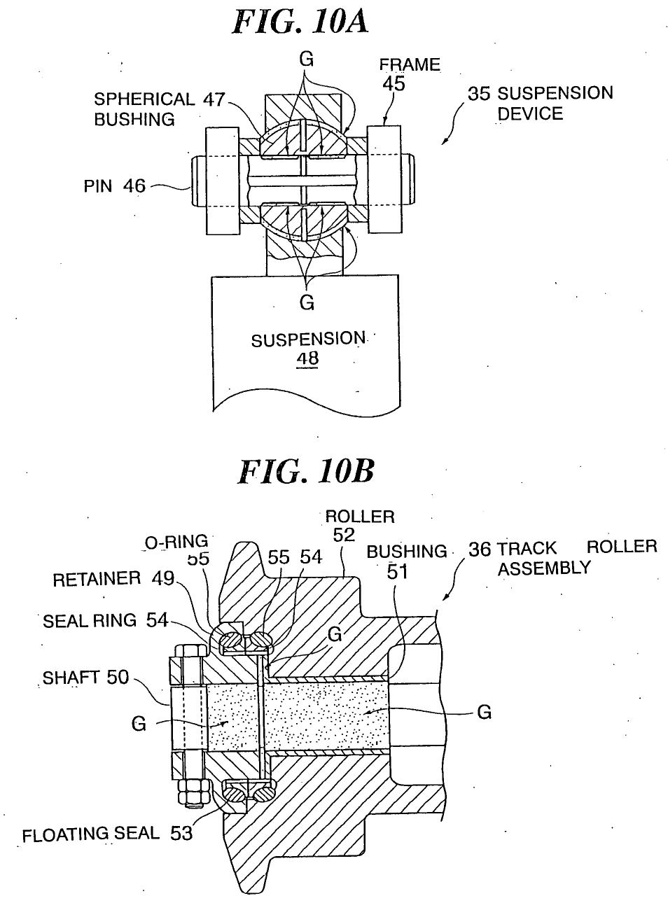

Each connecting portion of a crawler track assembly 33 of a crawler vehicle shown in FIG. 9A, an equalizer bar suspension 34 supporting a vehicle body of a bulldozer shown in FIG. 9B, a suspension equipment 35 of a dump truck shown in FIG. 10A and a roller assembly 36 of a crawler track assembly shown in FIG. 10B has substantially the same basic structure as that of the bucket connecting devices 9A and 9B according to the first and second embodiments. That is, one component (one link set 37, a main frame 41, a vehicle frame 45 and a roller retainer 49) and the other component (the other link set 40, an equalizer bar 44, a suspension 48 and a track roller 52) are connected each other in a rotatable and turnable manner. Each of the later component is arranged via a bearing axis (a crawler pin 38, an equalizer pin 42, a supporting pin 46 and a roller shaft 50), which is supported by the former component, and a bearing bushing (a crawler bushing 39, an equalizer bushing 43, a spherical bushing (two-degree-of-freedom) 47 and a roller bushing (a collar bushing) 51), which is fitted onto the bearing axis. Accordingly, applying the techniques according to the present invention to such the connecting portions can give the same action and effect as that of the first and second embodiments. In FIG. 9A, FIG. 9B, FIG. 10A and FIG. 10B, the sintered sliding material according to the present invention is preferably combined with a portion represented by G in each figure.

For example, in a connecting device arranged at a connecting portion of a hydraulic excavator, a seizing resistance and a lubricating interval thereof are depends on a combination of a bearing bushing and a bearing axis arranged in the bearing bushing, in which the bearing bushing and the bearing axis comprises the connecting device. Accordingly, either one of the bearing bushing or the bearing axis is preferably made of a sliding material according to the present invention.

So, a connecting device, according to this embodiment, connects a pair of components in a rotatable and turnable manner, in which one component is arranged via a bearing axis supported by the other component and a bearing bushing fitted onto the bearing axis, or connects a pair of components in a rotatable and turnable manner and also receiving a thrust load applied between the components by a thrust bearing, in which one component is arranged via a bearing axis supported by the other component and a bearing bushing fitted onto the bearing axis.

In the connecting device, it is possible that one or more elements of the bearing axis, the bearing bushing and the thrust bearing are made of a sliding member.

And, the sliding member comprises a back metal and a sintered sliding body combined with the back metal,

wherein the sintered sliding body is composed of a sintered compact containing Cu or Cu alloy in an amount of 10 to 95 wt % and a residue made of Mo and having a relative density of 80% or more, and the back metal is any one of a back metal of the bearing, a substrate of the bearing axis and a substrate of a spherical bushing.

In the aforesaid connecting device, since one or more element of the bearing axis, a bearing bushing or a thrust bearing which are arranged at a connecting portion are made of a sliding material having a sintered sliding body made of a sintered compact composed of Cu or Cu alloy in an amount of 10 to 95 wt % and a residue of Mo, in which the sintered compact has a relative density of 80% or more, the connecting device can be suitably used under severe sliding conditions such as a high-bearing stress and slow-speed sliding condition.

A connecting device, according to this embodiment, connects a pair of components in a rotatable and turnable manner, in which one component is arranged via a bearing axis supported by the other component and a bearing bushing fitted onto the bearing axis.

In the connecting device, it is possible that the bearing axis is made of a sliding member, and

the bearing bushing is made of a steel pipe, which is not heat-treated for hardening and is formed with necessary lubricating grooves at a sliding surface thereof.

In such a case, the sliding member comprises a back metal and a sintered sliding body combined with the back metal,

wherein the sintered sliding body is made of a sintered compact composed of Cu or Cu alloy in an amount of 10 to 95 wt % and a residue made of Mo principally, in which the sintered compact has a relative density of 80% or more, and

the back metal is a substrate of the bearing axis.

A connecting device, according to this embodiment, connects a pair of components in a rotatable and turnable manner, in which one component is arranged via a bearing axis supported by the other component and a bearing bushing fitted onto the bearing axis.

In the connecting device, it is possible that the bearing axis is made of a sliding member, and

the bearing bushing is made of a Fe—C based, a Fe—C—Cu based or a Cu—Sn based oil retaining sintered material.

In such a case, the sliding member comprises a back metal and a sintered sliding body combined with the back metal,

wherein the sintered sliding body is made of a sintered compact composed of Cu or Cu alloy in an amount of 10 to 95 wt % and a residue made of Mo principally, in which the sintered compact has a relative density of 90% or more, and

the back metal is a substrate of the bearing axis.

In the connecting device, the sintered compact is preferably made such that a Mo compact is sintered simultaneously with being infiltrated with Cu or Cu alloy. And, the sintered compact preferably contains Mo in an amount of 35 to 75 wt % and has a porosity of 7% or less by volume.

In the connecting device, the Mo compact is preferably made of Mo powder having an average grain size of 10 μm or less and contains a solid lubricant, having an average grain size of 30 μm or more, in a content of 5 to 60% by volume and/or hard particles in a content of 0.2 to 10% by volume.

And, in the connecting device, a Cu alloy phase in the sintered compact may contain Sn of 5 to 20 wt % and one or more elements selecting from the grope consisting of Ti of 0.2 to 5 wt %, Al of 0.2 to 14 wt %, Pb of 0.2 to 15 wt %, P of 0.1 to 1.5 wt %, Zn of 0.1 to 10 wt %, Ni of 0.1 to 10 wt %, Co of 0.1 to 5 wt %, Mn of 0.1 to 10 wt % and S of 0.1 to 3 wt %. This Cu alloy phase can more improve sintering performance, infiltrating performance and strength. The aforesaid all elements such as Al, Pb, Ni and Si are not necessarily added. For example, based on the fact that P of 0.1 wt % or more improves flowability, reducing ability and wettability, the lower limit of addition amount of P, Zn, Ni, Co, Mn and Si is preferably set at 0.1 wt %.

And, in order to improve abrasion resistance of the sintered sliding material, hard particles having an average grain size of 1 to 50 μm are preferably contained therein in a content of 0.2 to 10% by volume.

In each of the connecting devices, the bearing axis is made of a sliding member having a sintered sliding body made of a sintered compact composed of Cu or Cu alloy in an amount of 10 to 95 wt % and a residue made of Mo principally, in which the sintered compact has a relative density of 80% or more, so as to be designed to have a part of the sliding performance. This makes it possible to use an inexpensive bearing bushing as a member slid with respect to the bearing axis, causing cost reduction.

And, in a connecting device equipped with a bearing bushing which is made of an oil retaining sintered material capable of retaining a large amount of lubricating oil or lubricating compound, a sliding surface thereof can be stably lubricated with the lubricating oil for a long period thereby to extend a lubricating interval remarkably.

And, in each of the aforesaid connecting devices, the bearing axis, which is designed to have a part of the sliding performance, is easily detachable compared with the bearing bushing. So, when the sliding performance is deteriorated, the bearing axis can be easily exchanged for a new one or repair by filling abraded portions with the sintered sliding material for recovering the sliding performance. Accordingly, maintenance performance can be improved remarkably.

And, in the connecting devices, the bearing axis is preferably formed with the sintered sliding body at supported portions of the bearing axis by the component. Accordingly, even if the bearing axis is applied with a large load and therefore abraded with the component at the supported portions by turning-micromotion and flexure thereof, generation of abnormal noise can be prevented. In such a case, even if the component supporting portions of the component supporting the bearing axis will be made of a relatively soft material, such as S45C normalized steel, having Rockwell hardness of about HRC 25, a Mo metal phase contained in the sintered sliding material combined with the bearing surfaces of the bearing axis does not damage the supporting portions of the component. Accordingly, the supporting portion is not necessarily subjected to a heat-treatment for hardening, such as an induction hardening treatment, in order to improve seizing resistance and abrasion resistance, providing an advantage in cost

And, the aforesaid connecting device may be suitably used for any one of a connecting means of an operating machine, a track link and a track roller of a crawler vehicle, an equalizer bar suspension supporting a vehicle of a bulldozer and a suspension unit of a dump track.

In addition, the aforesaid connecting device can be used under a sliding condition in which a bearing stress applied to a sliding surface is 300 kgf/cm² or more and a sliding speed is 2 m/mim or less.

### EXAMPLE 1

Next, the preferred examples of the present invention will be described in detail with reference to accompanying drawings.

(Producing Method of Sintered Sliding Material)

In this example, using Mo(1) powder (an average grain size of 0.8 μm), Mo(2) powder (an average grain size of 4.2 μm), NiO (an average grain size of 0.7 μm), atomized Cu powder (manufactured by Nippon Atomized Metal Powder Corporation, SFR—Cu, an average grain size of 0.8 μm), Ni powder (an average grain size of 0.8 μm), TiH powder under #350 mesh and Sn powder under #350 mesh, various types mixed powder shown in table 1 were prepared. And, each mixed powder was blended with paraffin wax of 3 wt % with respect to the mixed powder and then formed with a pressure of 2 ton/cm² into a cylindrical-shaped compact with an inner diameter of 46 mm and a height of 50 mm. Then, each compact thus obtained was sintered at 950 to 1250° C. for 1 hour and then cooled with N₂ gas.

TABLE 1
CONPOSITIONS(wt %)

| | 0.8 | | | | | | | | | | | |
|---|---|---|---|---|---|---|---|---|---|---|---|---|
| | μm | 4.7 μm | CE25 | 1.2 μm | UNDER#350 | | | | | | | |
| | Mo1 | Mo2 | Cu | Ni | TiH | Pb | Sn | 1150° C. | INFILTRANT 1 | INFILTRANT 2 | 1250√ C. | 1470° C. |
| A1 | 100 | | | | | | | 73.2 | 9.28 | 9.31 | | |
| A2 | | 100 | | | | | | 65.5 | 9.18 | 9.21 | | |
| A3 | | Bal. | 5 | | | | | 70.5 | | | | |
| A4 | | Bal. | 4.25 | | 0.25 | 0.5 | | 88.7 | | | | |
| A5 | | Bal. | 4.45 | | 0.45 | | 0.3 | 79.1 | | | | |
| A6 | | Bal. | 2.5 | 2.5 | | | | 68.2 | | | 91.2 | |
| A7 | | Bal. | | 5 | | | | 63.4 | | | | 98.8 |
| A8 | | 35 | 58.5 | | | | 6.5 | 97.8 | | | | |
| A9 | | 50 | 45 | | | | 5 | 98.3 | | | | |
| A10 | | 70 | 27 | | | | 3 | 98.9 | | | | |
| INFILTRANT | | | Bal. | | | | 10 | | | | | |
| 1 | | | | | | | | | | | | |
| INFILTRANT | | | Bal. | | | | 20 | | | | | |
| 2 | | | | | | | | | | | | |

The No.A1 sintered compact (density; 4.65 g/cm³) made of the Mo(1) powder having an average grain size of 0.8 μm principally shows remarkable contractility at 950° C. and therefore demonstrates well sintering ability. And, at each temperature of 1100° C., 1150° C. and 1200° C., while the sintering ability is nearly saturated, remarkable contractility of coefficient of contraction of 14.6% is shown and a relative density is increased up to 74% (a porosity of 26%).

On the other hand, the No.A2 sintered compact (a density; 5.82 gr/cm³) made of the Mo(2) powder having an average grain size of 4.7 μm principally shows contractility of coefficient of contraction of 4.5 wt % by sintering and demonstrates sufficient sintering ability not as high as the No.A1 sintered compact.

Each of the sintered compacts made of the Mo(1) powder principally and the Mo(2) powder principally take the form of a high-strength porous structure having a relative density of about 66 to 74% and a porosity of about 25 to 34% (referring to a date showing a relative density at 1150° C. in the table 1).

By the way, since a conventionally Cu based or a Fe based sintered oil-retaining bearing utilizes discharge pores of Sn and Cu as pores, the diameter of the pore is large of 10 to 40 μm. The large size pore has an advantage for preventing early occlusion of the pore, however, has disadvantages described below: 1) a hydraulic pressure applied to a sliding surface is easily released, whereby it becomes difficult to form a lubricant oil film under a boundary lubricating condition; 2) a pumping action of a lubricating oil on a sliding surface becomes small, whereby the lubricating oil is flowed out remarkably through the pores; and 3) a lubricating oil is unevenly distributed on a sliding surface owing to gravity, whereby seizing owing to an insufficient lubricating oil occurs early depending on a direction in which a load is applied.

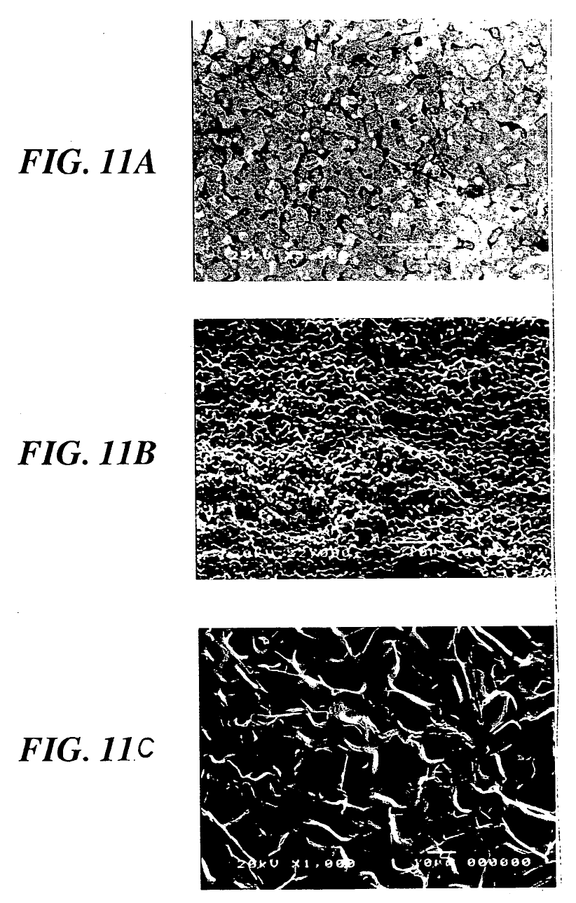

On the contrary, in the No.A1 sintered compact in this example, as shown in FIG. 11A of a photograph showing a cross-sectional structure of the No.A1 sintered compact sintered at 1185° C. and FIG. 11B of a photograph showing a structure of a fracture surface thereof, fine pores having an average grain size of 0.3 μm or less are finely distributed while being communicated each other to form a skeleton structure. Accordingly, in the No.A1 sintered compact, a permeation force of a lubricating oil is increased remarkably so that a large amount of lubricating oil can be retained and also an outflow of the lubricating oil can be decreased during sliding. Accordingly, the aforesaid disadvantages of a conventional Cu based or a Fe based sintered oil retaining bearing can be essentially solved. And, fluid-lubricating property can be easily accomplished under a slow sliding speed compared with the aforesaid conventional sintered oil retaining bearing. In addition, filling a lubricating oil or a lubricating compound of a lubricating oil and a wax into the fine pores of the Mo sintered compact allows the bearing to use under both a high-sliding speed condition and a slow-speed sliding condition.

In general, a sintered compact made of Mo powder is sintered at 2300 to 2500° C. in hydrogen gas stream, in which case the sintered compact has a density of 9.2 to 9.5 gr/cm³ (a relative density of 90 to 93% and coefficient of contraction of 17.5 to 20%). And then, the sintered compact is hot-worked so as to have a higher density. In addition, the Mo powder compact is hardly sintered at a pre-sintering temperature of 1150° C. and sintered at a sintering temperature of 1300° C. to have a contractility of 2 to 4%. As just described, a Mo powder may be a material hard to be sintered.

On the contrary, in this example, vacuum sintering at 0.01 to 1 torr is performed so as to produce a liquid phase of a low-melting oxide (for example, MoO₃ (a melting point; 795° C., a boiling point; 1151° C.) formed on surfaces of a raw powder for the purpose of promoting sintering. This is obviously shown by a photograph of FIG. 11C. From the photograph, portions, in which sintering is partially promoted in clusters by formation of liquid phases of a low-melting oxide, are scattered and cracks occurs partially in the portions, where the sintering is remarkably promoted, at a cooling process. Accordingly, a positive addition of a low-melting oxide, such as MoO₃, to a Mo powder improves sintering ability of a liquid phase. And, moving a sintering temperature to higher reduces the low-melting oxide or volatilizes and discharges oxygen in the oxide. As a result, a high-density Mo sintered compact can be obtained. And, also by adjusting oxygen potential during sintering, a high-density Mo sintered compact can be also obtained.

In exchange for MoO₃ which is an example of the low-melting oxide, it is preferable to add oxide (NiO, CoO, FeO, Cuo and the like) of Ni, Fe, Cu, Co, Sn and the like, which are easy to be reduced by vacuum sintering, as an oxygen source for promoting sintering ability of a Mo powder. In such a case, in view of the fact that a conventional liquid phase is sintered to be completely densified when oxide of 10% by volume is added, an addition amount of oxygen is set at as much as about 0.1 to 3.0 wt %.

In the No.A1 sintered compact and the No.A2 sintered compact, Young's module of each compact is decreased to about 30 to 50% of Young's module 30000 kgf/mm² of Mo owing to pores contained in each sintered compact at a constant rate, therefore bearing performance like an Cu based ingot material can be achieved. And, the No.A1 sintered compact has Vickers hardness of Hv=92 and the No.A2 sintered compact has Vickers hardness of Hv=66. This shows that each of the sintered compacts has hardness excellent in conformability as a sliding material. And, each of the sintered compacts can have the same radial crushing strength (15 kgf/mm² or more, tensile strength of about 7 kgf/mm² or more) as a conventional oil retaining bearing.

On the contrary, each of No.A3 to No.A7 sintered compacts was prepared in order to study an effect of addition of one or more elements of Cu, Cu alloy and Ni in an amount of 5 wt % to Mo powder while holding an amount of the Mo powder to be 95 wt % on sintering ability. Each of the No.A3 to No.A7 sintered compacts is remarkably promoted in sintering ability at sintering temperatures over each melting point of Cu, Cu alloy and Ni. Especially, when the No.A7 compact to which Ni of 5 wt % is added is sintered, Ni is transformed into a liquid phase over 1460° C. and therefore densification of the compact is promoted remarkably. This result coincides with a known fact. And, in a CuTiPb based No.A4 sintered compact and a CuTiSn based No.A5 sintered compact, sintering ability of each compact is increased remarkably at a sintering temperature of 1150° C. Because, the CuTiPb based No.A4 sintered compact is improved in wettability between Mo and Cu alloy owing to a compatibility of Ti to Mo, a solid soluble property of Mo with Pb and a strong affinity between Ti and Pb, and the CuTiSn based No.A5 sintered compact is easily improved in wettability from the aforesaid result of the infiltrant.

In this example, the No.A1 sintered compact of the table 1 is sintered at 1000 to 1200° C. in such a manner that a compact of an infiltrant 1 of the table 1 is placed on the No.A1 compact and then the No.A1 sintered compact is sintered simultaneously with being infiltrated with the infiltrant compact, resulting in producing a high-density Mo based infiltrating-sintered compact having no pores. And, using a compact of an infiltrant 2 and the No.A1 sintered compact, a Mo based infiltrating-sintered compact is produced by the same infiltrating-sintering manner. In addition, using a compact of the infiltrant 1 and the No.A2 compact, a Mo based infiltrated sintered compact is produced in the same manner, and using a compact of the infiltrant 2 and the No.A2 compact, a Mo based infiltrated sintered compact is produced in the same manner. Here, each of the infiltrant 1 compact and infiltrant 2 compact (both the infiltrant 1 and the infiltrant 2 are a Cu based alloy for infiltration) is prepared such that a predetermined mixed powder (as shown in the table 1) is applied with a pressure of 4 ton/cm² to be formed into the same cylindrical shape as the No.A1 and No.A2 sintered compacts, in which a height of the compact is adjustable in order to adjust each infiltrating amount.

A infiltrating sintering at 1150° C. according to a producing method of a Mo based infiltrated sintered compact using the infiltrating sintering manner allows a density of the No.A1 compact to increase from 4.65 gh/cm³ (relative density; about 46%) to 9.31 gr/cm³. And, the Mo based infiltrated sintered compact produced by the No.A1 compact and the infiltrant 2 is hardened to have hardness of Hv325.

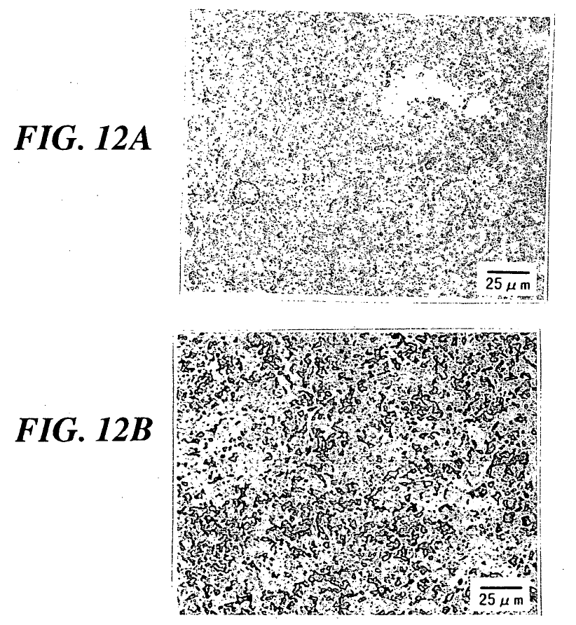

FIG. 12A is a photograph showing a structure of a Mo based infiltrating-sintered compact produced by the No.A1 compact and the infiltrant 2 and FIG. 12B is a photograph showing a structure of a Mo based infiltrating-sintered compact produced by the No.A2 compact and the infiltrant 2. From the figures, it is found that each Mo based infiltrating-sintered compact has few pores (porosity; 7% or less by volume) therein and therefore is strengthened. And, the Mo based infiltrating-sintered compact shown in FIG. 12A produced using the finer grained Mo(1) powder (an average grain size of 0.8 μm) has a very fine and uniform structure compared with the Mo based infiltrating-sintered compact shown in FIG. 12B produced using the coarser grained Mo(2) powder (an average grain size of 4.7 μm). This results show that the Mo based infiltrating-sintered compact, shown in FIG. 12A, has sliding performance superior to the Mo based infiltrating-sintered compact, shown in FIG. 12B.

And, a shrinkage rate in size of each No.A1 compact and No.A2 compact to which the infiltrating-sintering is applied is examined. As a result, while the No.A1 filtrated sintered compact has shrinkage rate of 10% at 1000° C., 8.1% at 1150° C. and 7.3% at 1200° C., the No.A2 infiltrated sintered compact has small shrinkage rate as 3.7% or less. And, the difference in the shrinkage rate affects sintering ability of a Mo powder which becomes a base of a sintered compact. Especially, a bronze alloy containing a large amount of Sn is preferably infiltrating-sintered at 1150° C. or less in view of evaporation of Sn. Furthermore, it is found that a infiltrating-sintering method according to this example is preferable for producing a high-density sintered sliding material composed of a Mo metal phase in a content of 40 to 60% by volume and a residue made of Cu or Cu alloy.

When a powder compact composed of Mo powder (Mo(1) powder, Mo(2) powder), to which hard particles (for example, TiC, TiN, TiCN, W, ferromolybdenum (50 to 70 wt % Mo—Fe), Si₃N₄ and the like) and a solid lubricant (for example, CaF₂, graphite and the like) are added for the purpose of increasing abrasion resistance, are infiltrating-sintered by to the aforesaid infiltrating sintering method, a high-strength oilless sintered sliding material excellent in lubricating property can be provided. Especially, by using fine grained Mo powder, even if a larger and softer solid lubricant having than the Mo particle are added in a large amount, a sintered sliding material excellent in sliding performance while keeping its strength can be provided (for example, referring to Japanese Patent Number 3214862 proposed by the inventors). Accordingly, when at least either one of a connecting pin or a bushing of a connecting device of a hydraulic excavator and the like are formed by combining with a Mo based or a Mo—Cu (Cu alloy) based sintered sliding material containing a solid lubricant, the connecting device can be used with a long lubricating interval or without lubricating. Here, a suitable size of the solid lubricant is about 3 times, more preferably 5 times a grain size of Mo powder. This relation can be derived from a geometrical relationship (as shown in FIG. 8).

In addition, in this example, an electrolytic Cu powder (CE15, manufactured by FUKUDA METAL FOIL POWDER Co., Ltd.), the Mo(2) powder, Sn powder, TiH powder, Pb powder and Fe-27 wt % P powder under #350 mesh or less were prepared to have compositions shown in table 2. At the same time, each powder was prepared to contain Mo in an amount of 0, 5, 10, 15 and 25 wt %. After forming each powder, each compact was sintered at 850 to 950° C. Then, each sintered compact is examined in a liquid-phase sintering ability. Here, the TiH powder, the Pb powder and the P powder are added for improving wettability with Mo powder.

TABLE 2
COMPOSITION (wt %)

| | | | | | | | | 865° | 885° |
|---|---|---|---|---|---|---|---|---|---|
| | Cu(CE15) | Mo2 | Sn | Cu20Sn | TiH | Pb | Fe27P | C. | C. |
| B1 | Bal. | 0 | 6 | 28 | 0.7 | 8 | 2 | 8.5 | |
| B2 | Bal. | 5 | 6 | 28 | | 8 | | 7.65 | |
| B3 | Bal. | 5 | 6 | 28 | 0.7 | 8 | 2 | 8.6 | |
| B4 | Bal. | 10 | 6 | 28 | 0.7 | 8 | 2 | 8.9 | |
| B5 | Bal. | 15 | 6 | 28 | 0.7 | 8 | 2 | 9.1 | |
| B6 | Bal. | 25 | 6 | 28 | 0.7 | 8 | 2 | | 9.2 |

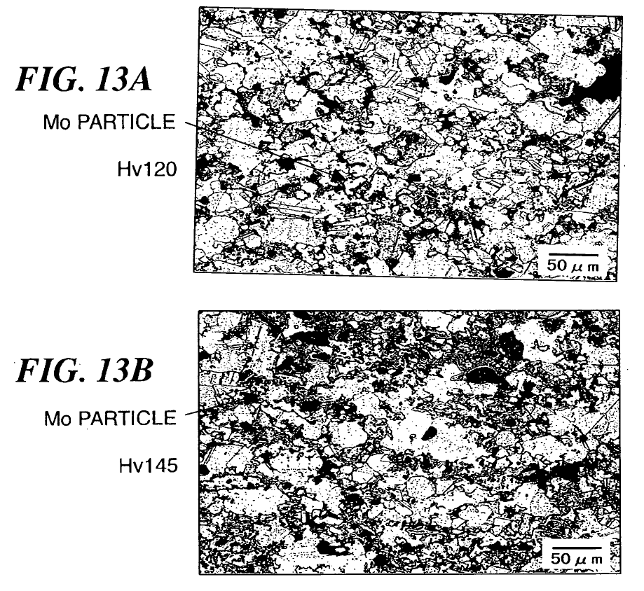

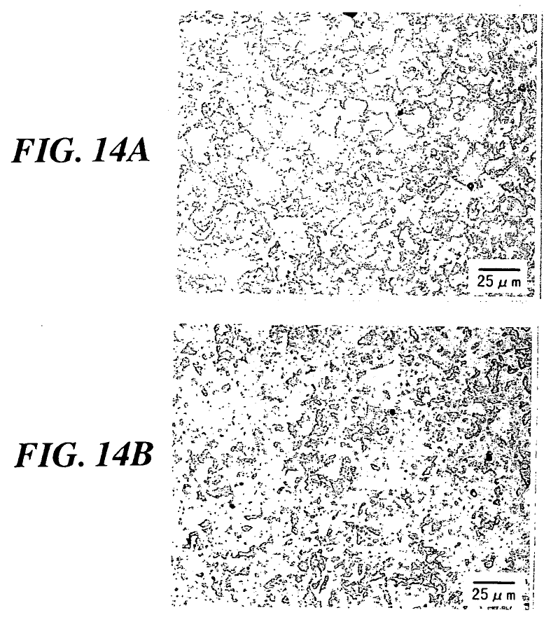

As a result, as shown the right column of the table 2, wettability is improved so as to provide a high-density Cu alloy-Mo based sintered compact even if a large amount of Mo particles are distributed therein. And, each of FIG. 13A, FIG. 13B, FIG. 14A and FIG. 14B shows a structure of a No.B3 sintered compact, a No.B5 sintered compact, in table 2, a No.A9 sintered compact and a No.A10 sintered compact, in table 1, respectively. Those figures show that each compact is sintered to have a very high density. Especially, the No.B3 and the No.B5 sintered compacts, to which Ti and Pb are added so as to improve wettability at liquid phase sintering, can be increased in a sintered density (a porosity of the sintered compact; 7% or less by volume) by adjusting a sintering temperature to 865° C. And, the No.B3 and the No.B5 sintered compacts have hardness of Hv125 and Hv 145, respectively, resulting in obtaining sufficient strength for a sliding material used under a high-bearing stress. And, these sliding materials are expected to be used for a high-speed and high-bearing stress sliding material excellent in abrasion resistance and seizing resistance under lubricating.

### EXAMPLE 2

(Bearing Test)

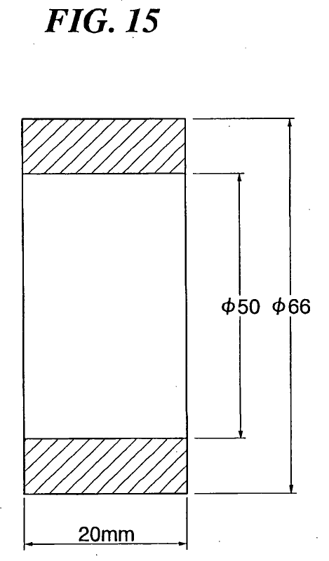

In this example, under a condition in which a sintered sliding material, according to the present invention, was combined with either one of a test bearing bushing having a shape, shown in FIG. 15, or a test bearing axis, a bearing test between the bearing bushing and the bearing axis was performed. Each sliding surface of the bearing bushing and bearing axis, other than sintered pores, was prepared to have a lathe machining roughness of about 2 to 5 μm. In a case in which the sintered sliding material, according to the present invention, was combined with the test bearing bushing, the test bearing axis with which the test bearing bushing was slid was made of a S45C carbon steel prepared such that a surface layer thereof was induction-hardened and quenched (at 160° C.) to have hardness of HRC56 and then finished to have roughness of 1 to 3 μm or less by grinding. On the other hand, in a case in which a sintered sliding material, according to the present invention, was combined with the test bearing axis, the test bearing bushing with which the test bearing axis was slid was made such that a mixed powder of 4600 iron powder under #100 mesh and graphite powder (an average grain size of 6 μm, LONZA KS6) of 0.7 wt % was blended with an organic lubricant (accla wax) of 0.7 wt % and formed at a forming pressure of 6 ton/cm². And, the formed powder compact was vacuum-sintered at 1150° C. for 2 hours and quenched with N₂ gas, and then tempered at 200° C. for 1 hour. And, after the compact was impregnated with oil, the compact was machined into a shape shown in FIG. 15. And, both the test bearing bushings were impregnated with a lubricant containing an extreme-pressure additive (an addition amount of S is 0.8 wt %) equivalent of ISO VG68. In addition, in this example, an infiltrating-sintered compact produced such that a compact formed by the Mo(2) powder and a water grass granular graphite having an average grain size of 0.1 to 0.3 mm was infiltrating-sintered using the infiltrant 2 was also subjected to the bearing test.

In this bearing test, at an oscillating angle of 10° and 160°, each of the test bearing bushing and the test bearing axis was oscillated being applied with a bearing stress, each of which was incremented by 50 kgf/cm² every 2000 times oscillation. And, the last bearing stress when friction coefficient therebetween was rapidly increased up to 0.3 or more was defined as a critical bearing stress against seizing. In this test, a largest bearing stress was 1300 kgf/cm², an average speed at the small oscillating angle was 0.05 m/min and an average sliding speed at the large oscillating angle was 0.8 m/min. Test results are shown in table 3 (the small oscillating angle) and table 4 (the large oscillating angle). Since there is no difference therebetween, hereinafter, the test result shown in table 3 was described.

TABLE 3
SMALL OSCILLATING ANGLE TEST RESULT(AVERAGE SLIDING SPEED 0.05 m/min)

| SLIDING | | | | | | | | | |
|---|---|---|---|---|---|---|---|---|---|
| MATERIAL | | | | | | | | | |
| OF | | SLIDING MATERIAL OF AXIS | | | | | | | |
| BUSHING | S45CIQT | A1/INFILTRANT 2 | A2/INFILTRANT 2 | A8 | B1 | B3 | B4 | B5 | D |
| A1 | 1300 | | | | | | | | |
| A2 | 1300 | | | | | | | | |
| A5 | 1300 | | | | | | | | |
| C | 150 | 1300 | 1150 | 950 | 250 | 250 | 450 | 700 | 1300 |
| D | 1050 | | | | | | | | |
| E | 400 | | | | | | | | |
| S45CIQT | | | | | | | | | 1000 |

C: 4600-0.7GrFe BASED SINTERED MATERIAL
D: 1-3 wt % Mo GRANULAR Gr/INFILTRANT 2
E: CARBURIZED Fe-0.7Gr-20Cu-10SKH51

TABLE 4
LARGE OSCILLATING ANGLE TEST RESULT(AVERAGE SLIDING SPEED 0.8 m/min)

| SLIDING | | | 60Mo | 35Mo | | | | | |
|---|---|---|---|---|---|---|---|---|---|
| MATERIAL | | | | | | | | | |
| OF | | SLIDING MATERIAL OF AXIS | | | | | | | |
| BUSHING | S45CIQT | A1/INFILTRANT 2 | A2/INFILTRANT 2 | A8 | B1 | B3 | B4 | B5 | D |
| A1 | 1300 | | | | | | | | |
| A2 | 1200 | | | | | | | | |
| A5 | 1300 | | | | | | | | |
| C | 150 | 1300 | 1200 | 900 | 200 | 250 | 500 | 800 | 1300 |
| D | 950* | | | | | | | | |
| E | 450 | | | | | | | | |
| S45CIQT | | | | | | | | | 900* |

C: 4600-0.7GrFe BASED SINTERED MATERIAL
D: 1-3 wt % Mo GRANULAR Gr/INFILTRANT 2
E: CARBURIZED AND QUENCHED Fe-0.7Gr-20Cu-10SKH51
*DRY TYPE TEST

From a result of the test bushings in which the S45C induction-quenched and tempered test bearing axis is combined with various sintered sliding materials, a No.A1, a No.A2 and a No.A5 Mo based porous materials show a remarkable high critical bearing stress against seizing compared with the standard oil retaining sintered sliding materials (C) and (D). And, a sliding material (D), in which a Mo matrix containing graphite dispersed therein was infiltrated with Cu—Sn alloy, forms a dry type sliding material capable of solid-lubricating and therefore will be suitably used as a sliding material for an oilless bushing which does not need lubricating. And, an outflow of a lubricating oil from the bearing bushing when the large angle oscillating test was performed at a temperature of 40° C. and a bearing stress of 300 kgf/cm² was examined. As a result, an outflow of the lubricating oil from each oil retaining bushing with which each of the A1, A2, A5 Mo based porous material is combined is small as under ⅕ that of a bearing bushing made of a comparative sliding material (E). This is because pores of the sintered compact of the A1, A2 and A5 Mo based porous materials are very fine. In addition, in a bushing consisting of a bearing bushing made of a ferrous oil retaining sintered material and the test bearing axis formed such that a high-density Mo based sliding material is combined with the outer surface thereof, the same results are obtained. Especially, from a test result of effect of an amount of Mo to be added to Cu alloy, an addition of Mo in an amount of 5 wt % or more, more preferably 10 wt % or more, improves critical bearing stress against seizing remarkably.

### Embodiment 3

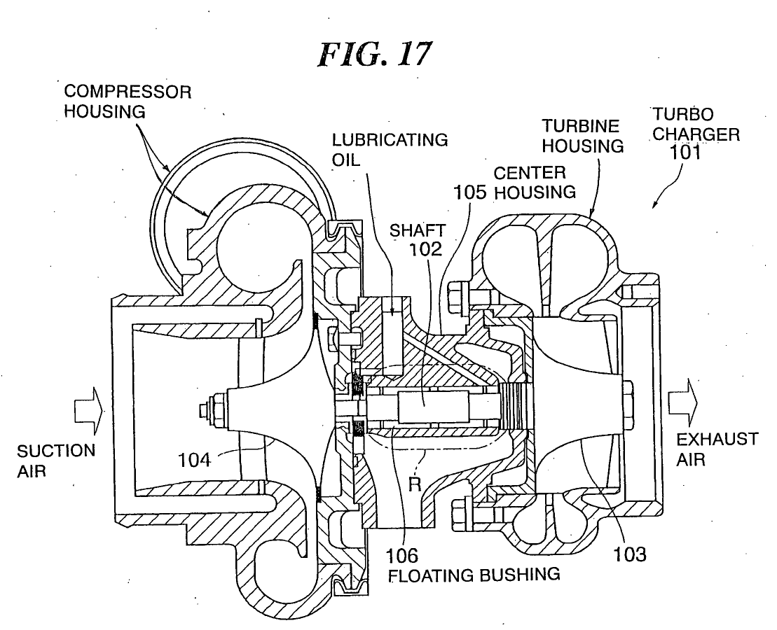

FIG. 17 is a view schematically showing a structure of a turbo charger device according to the first embodiment of the present invention.

The turbo charger device 101, according to this embodiment, is provided with a turbine shaft 102, a turbine wheel 103 and a compressor wheel 104, which are connected by the turbine shaft 102, and a floating bushing 106 arranged between a bearing surface formed on a center housing (a base body) 105 and the turbine shaft 102. In this device, by rotating the turbine wheel 103 by exhaust gas discharged from an engine (not shown), the compressor wheel 104 arranged on an axis of the turbine wheel 103 is operatively rotated so as to send a large amount of air into a combustion chamber of the engine.

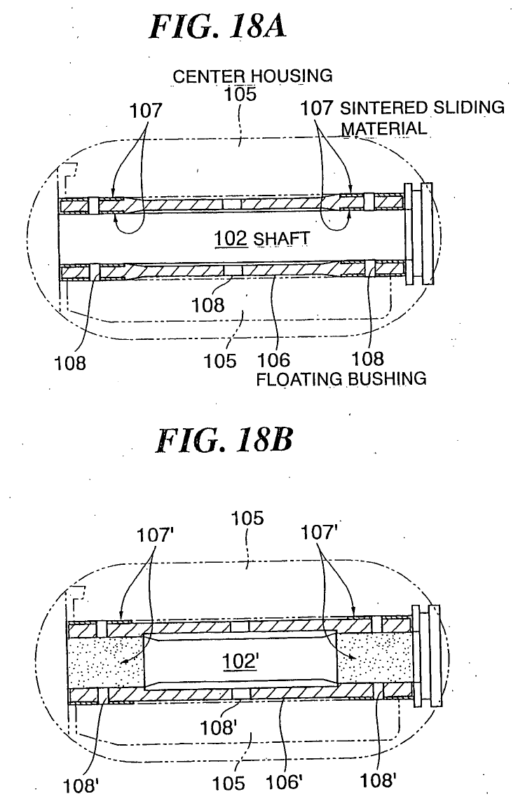

In this embodiment, as shown in FIG. 18A, an outer surface and an inner surface of the floating bushing 106, in which the outer surface is slid with a bearing surface formed on the center housing 105 and the inner surface is slid with the turbine shaft 102, are formed with a sliding surface with which a sintered sliding material 107, according to the present invention, is combined. In this figure, oil supplying bores 108 are also shown.

Next, the sintered sliding material will be described in detail.

The sintered sliding material may be a porous sintered material composed of Mo or Mo alloy, containing one or more elements selected from the group consisting of Cu, Ni, Fe and Co in an amount of 10 wt % or less, wherein the porous sintered material; having a porosity of 10 to 40% by volume, contains a lubricating oil or a lubricating compound of a lubricating oil and a wax filled in the pores. Alternatively, the sintered sliding material may be a porous sintered material composed of Mo or Mo alloy containing one or more elements selected from the group consisting of Cu, Ni, Fe and Co in an amount of 10 wt % or less, wherein the porous sintered material, having a porosity of 10 to 40% by volume, contains a low-melting metal which is principally made of one or more elements selected from the group consisting of Pb, Sn, Bi, Zn and Sb and adjusted to have a melting point of 450° C. or less or an alloy of the low-melting metal filled in the pores. And, the pores sintered compact preferably contains Mo in a content of 50 to 90% by volume.

Since the aforesaid sintered sliding material has a structure which has a parent phase composed of Mo or Mo alloy principally excellent in seizing resistance and can supply a sufficient amount of lubricating compound, such as Pb, onto a sliding surface, a sliding material having excellent seizing resistance and abrasion resistance as well as excellent conformability at sliding under a high-speed and high-temperature condition can be provided.

And, the aforesaid porous sintered compact composed of Mo principally preferably contains one or more elements or alloys selected from the group consisting of iron, Cu, Ni and Co in an amount of 10 wt % or less for the purpose of improvements in strength thereof and economical efficiency. And, the porous sintered compact preferably has a porosity of 7.5% or more by volume in view of a content of Pb in a lead bronze, or 10% or more by volume in view of infiltrating ability of the aforesaid low-melting metal.

In order to improve infiltrating ability of the aforesaid low-melting metal or an alloy thereof, at least either one or more groups are preferably contained, in which one group includes one or more elements selected from group consisting of Ti, Mg, Te, Ca, Ba and Se, excellent in affinity with Pb and Mo, and the other group includes one or more elements selected from the group consisting of Cu, Ni, Co and Al, excellent in solid solubility with Pb and also affinity with Mo.

In a sintered sliding material according to this embodiment, the porous sintered compact preferably contains one or more hard particles selected from the group consisting of intermetallic compound, carbide, nitride, oxide and fluoride, which are harder than Mo phase or bronze phase, dispersed therein in a content of 0.2 to 10% by volume. In such a case, the intermetallic compound preferably includes one or more intermetallic compounds selected from the group consisting of MoNi based, MoFe based, MoCo based, FeAl based, NiAl based, NiTi based, TiAl based, CoAl based and CoTi based intermerallic compounds and the like. And, the carbide preferably includes one or more carbide selected from the group consisting of TiC, WC and the like. And, the nitride preferably includes one or more nitrides selected from the group consisting of TiN, CrN, Si₃N₄ and the like. And, the oxide preferably includes one or more oxides selected from the group consisting of NiO, Cu₂O, CoO, TiO₂, SiO₂, Al₂O₃ and the like. And, the fluoride preferably includes CaF₂ and the like. This can improve abrasion resistance. In such a case, when taking damaging property against a counterpart into account, a dispersion content of the hard particles is preferably suppressed small as 5% or less by volume. And, the hard particles dispersed in a sintered compact is preferably selected so as to have a grain size larger than Mo particle for the purpose of preventing the hard particles from inhibiting sintering between Mo particles.

In this embodiment, a sintered sliding material may comprises a bronze alloy-Mo based sintered compact composed of a bronze alloy phase, containing Mo of 5 to 75 wt % and Sn of 5 to 20 wt %. And, the bronze alloy-Mo based compact preferably has a relative density of 90% or more.

Use of the sintered sliding material makes it possible to obtain a sliding material having excellent conformability at sliding under a high-speed and high-temperature sliding condition and a high-bearing stress and high-speed sliding condition as well as excellent seizing resistance and abrasion resistance.

In this embodiment, the lower limit of an addition amount of Mo is set at 5 wt %, because seizing resistant performance begins to be demonstrated under a bad lubricating condition when an addition amount of Mo is 5 wt %. However, the lower limit thereof is more preferably set at 10 wt % because substantially the same sliding performance as a sliding material made of pure Mo can be obtained. On the other hand, the upper limit of an addition amount of Mo is set at 75%, more preferably 60 wt %, in view of economical efficiency and convenience of a producing method using infiltrating sintering described later.

By the way, it is known that adding Mo of 5 wt % or more decreases strengths of a bronze based and a lead bronze based sintering materials (for example, referring to Patent literature 6).

In order to prevent the decrease of the strength of the material to which Mo of 5 wt % or more is added, in a sintered sliding material according to this embodiment, the bronze alloy phase preferably contains one or more elements selected from the group consisting of Ti of 0.2 to 5 wt %, Al of 0.2 to 14 wt %, Pb of 0.2 to 15 wt %, P of 0.1 to 1.5 wt %, Ni of 0.1 to 10 wt %, Co of 0.1 to 5 wt %, Mn of 0.1 to 10 wt % and Si of 0.1 to 3 wt %. Here, Ti decreases a melting point of Cu remarkably (in Cu-5 wt % Ti, a liquid phase is produced at 885° C.) and improves wettability when coexists with Pb and Sn. And, Ti does not form an intermetallic compound, which decreases sintering ability, when reacted with Mo. Thus, Ti improves sintering ability of the sintered compact and also improves strength of Cu alloy phase coexisted therewith. And, while Pb hardly forms a solid solution with Mo, a liquid phase of Pb forms a solid solution with Mo remarkably, therefore Pb also improves sintering ability of Mo (this property is confirmed by a sintering test of a Mo-Cu alloy based sintered compact as described later).

In the sintered sliding material, wettability thereof is improved by coexistence of Ti with Pb, as described above. Furthermore, the coexistence of Ti with Pb is very effective for dispersing Pb uniformly. When Pb will be dispersed in a sliding material uniformly, a formation of Pb depleted layers can be prevented and therefore a solid-lubricating property inherent in Pb compound can be well demonstrated (referring to Patent Publication No.H11-217637 proposed by the inventors). Accordingly, in this embodiment, a sliding material suitably used for a high-speed sliding portion of a turbo charger and the like can be obtained. And, in views of improvement in uniform dispersibility of Pb and formation of a Pb based compound, one or more elements selected from the group consisting of Mg, Ca, Ba, Zr, La, Li, Se, Sm and Te in an amount of 0.5 to 10 wt % are preferably contained in addition to Ti (as shown the former patent).

And, in the sintered sliding material, for the purpose of improvement in sulfur resistance of a sliding surface thereof, the bronze alloy-Mo based sintered compact preferably contains one or more elements of Al of 0.5 to 5 wt %, Ni of 1 to 5 wt %, Zn of 1 to 15 wt % and Si of 0.5 to 2 wt %. Especially, from a viewpoint of improvement in strength of the bronze alloy-Mo based sintered compact, it is more preferable to add Al and Ni thereto. And, in order to form a high-density bronze alloy-Mo based sintered compact by preventing foaming and sweating, which often occur during sintering, it is preferable to add one or more element of Ti, Al, Si, P and Fe in an amount of 0.1 to 2 wt % to the bronze alloy-Mo based sintered compact.

The aforesaid elements are added to the sintered sliding material in the form of a raw powder, a mother alloy and an intermetllic compound of the element. In a Cu based sliding material suitably used for a component of a floating bushing of a turbo charger, from an amount of Pb added to the materials described in the patent literatures 7 and 8, a Pb phase is dispersed and precipitated therein in an amount of 1.5 to 15 wt %. Accordingly, in the present invention, an addition amount of Pb is preferably set at 1.5 to 15 wt %. And, the Cu alloy phase in the bronze alloy-Mo based sintered compact may contain any one of Sn, Pb, Zn, Al, Si, P, Fe, Be, Ag, Mn and Cr, which are contained in a conventional bronze based sintered material, such as a lead bronze based, a phosphor bronze based, a Al bronze based sliding materials and various brass based sliding materials, in an suitable amount.

By the way, when Mo particles having a grain size of 10 μn or less are mixed with bronze particles such that Mo is contained in an amount of 5 to 75 wt % and then are sintered, the resultant sintered material has a structure composed of Mo phase formed by aggregating of Mo particles and bronze alloy phase, resulting in that sliding performance may not be demonstrated sufficiently ((A)). And, when a large amount of hard particles, inhibiting sintering ability of bronze alloy, are added to a raw material and then sintered, remarkable sintering inhibition may be caused ((B)).

In order to solve the aforesaid problems in the cases (A) and (B), a sintered sliding material, according to this embodiment, comprises a bronze alloy-Mo based sintered compact made such that a Mo powder compact is sintered simultaneously with being infiltrated with a bronze alloy based infiltrant, wherein the bronze alloy-Mo based sintered compact contains Mo in an amount of 35 to 75 wt %.

The sintered sliding material has a structure in which bronze alloy phases are dispersed in the sintered compact so that sliding performance can be demonstrated and further inhibition of sintering can be prevented.

Here, the infiltrating may be performed in such a manner that the a Mo compact is sintered at 900 to 1250° C. and then the obtained Mo sintered compact is infiltrated with a bronze alloy based infiltrant by another process. And, in the sintered sliding material, as an average grain size of Mo particle forming the Mo compact becomes small, an organizational uniformity is remarkably increased. For example, when a Mo compact formed by Mo particles having an average grain size of 0.8 μm is sintered simultaneously with being infiltrated with a bronze alloy based infiltrant, the sintered compact thus obtained has a structure in which fine bronze alloy phases having a grain size of 1 μm or less are dispersed, resulting in improving hardness and strength of the material remarkably.

By the way, when a solid lubricant added for achieving well seizing resistance is dispersed in a sintered compact in a large amount, remarkable deterioration in strength of the sintered compact may be caused.

In order to prevent such deterioration in the strength, in a sintered sliding material according to this embodiment, the Mo powder compact preferably contains at least either one of a solid lubricant, such as graphite and CaF₂ or a hard particle dispersing material, in a content of 5 to 60% by volume mixed therewith previously. When a solid lubricant enhancing self-lubricating is contained in the sintered sliding material, the soft solid lubricant is preferably prepared to have a grain size about 5 times a grain size of Mo particle so as to reduce concentrated of stress on the solid lubricant after sintering and therefore improve the strength. For this purpose, the Mo compact is preferably composed of Mo particles having a grain size of 10 μm or less and the solid lubricant preferably has a grain size of 30 μm or more. Self-lubricating by the solid lubricant begins to demonstrate when the solid lubricant is contained in a content of 5% or more by volume, however, in order to obtain sufficient self-lubricating, the solid lubricant is preferably contained in a content of 10% or more by volume. On the contrary, when the solid lubricant is contained in a content of 60% or more by volume, there is a problem in deterioration in strength. Accordingly, in the sintered sliding material, a content of a solid lubricant is set at 5 to 60% by volume.

In a sintered sliding material according to this embodiment, the bronze alloy-Mo based sintered compact preferably contains one or more hard particles selected from the group consisting of intermetallic compound, carbide, nitride, oxide and fluoride, which are harder than Mo phase or bronze phase, dispersed therein in a content of 0.2 to 10% by volume. In such a case, the intermetallic compound preferably includes one or more intermetallic compounds selected from the group consisting of MoNi based, MoFe based, MoCo based, FeAl based, NiAl based, NiTi based, TiAl based, CoAl based and CoTi based intermerallic compounds and the like. And, the carbide preferably includes one or more carbide selected from the group consisting of TiC, WC and the like. And, the nitride preferably includes one or more nitrides selected from the group consisting of TiN, CrN, Si₃N₄ and the like. And, the oxide preferably includes one or more oxides selected from the group consisting of NiO, Cu₂O, CoO, TiO₂, SiO₂, Al₂O₃ and the like. And, the fluoride preferably includes CaF₂ and the like. This can improve abrasion resistance. In such a case, when taking damaging property against a counterpart into account, a dispersion content of the hard particles is preferably suppressed small as 5% or less by volume. And, the hard particles dispersed in a sintered compact is preferably selected so as to have a grain size larger than Mo particle for the purpose of preventing the hard particles from inhibiting sintering between Mo particles.

In a sintered sliding material according to this embodiment, a content of Mo is regulated to 35 to 65 wt % so that the bronze alloy-Mo based sintered compact can have a thermal expansion coefficient of 1.1 to 1.5×10⁻⁵. For example, in a case of a turbo charger constructed such that a floating bushing is arranged between a bearing surface formed at a supporting base and a turbine axis, a clearances between the turbine axis and the floating bushing and a clearance between the floating bushing and the supporting base are tightly controlled so as to secure fluid lubrication with a lubricating oil at high-speed rotating. By keeping each clearance between the floating bushing and each of the turbine axis made of steel and the supporting base made of cast iron from being remarkably changed owing to a difference in the thermal expansion coefficients thereof (thermal expansion coefficients of steel and cast iron; 1.1 to 1.5×10⁻⁵), a sliding resistant property is increased so that occurrence of problems, such as seizing, can be prevented previously.

In this embodiment, since a content of Mo is prepared to be 35 to 65 wt % so that the bronze alloy-Mo based sintered compact can have thermal expansion coefficient of 1.1 to 1.5×10⁻⁵, a suitable sintered sliding material for use in a component of the floating bushing or a sliding material disposed on a sliding surface of the floating bushing can be obtained.

As described above, in this embodiment, since a sintered sliding material 107 is combined with an outer surface and the inner surface of the floating bushing 106, in which the outer surface is slid with a bearing surface formed on the center housing 105 is slid and the inner surface is slid with the turbine shaft 102, the turbo charger device 101 can be provided with excellent seizing resistance and abrasion resistance. In addition, a conventionally used bushing containing Pb has a problem in which lubricating property is deteriorated by depletion of Pb and deposition of CuS and environment is damaged. On the contrary, the floating bushing according this embodiment does not have such problems.

In the turbo charger 1 according to this embodiment, a clearance between the turbine shaft 102 and the floating bushing 106 and a clearance between the floating bushing 106 and the center housing 105 are tightly controlled so as to secure fluid lubrication with a lubricating oil at high-speed rotating. By keeping each clearance between the floating bushing 106 and each of the turbine shaft 102 made of steel and the center housing 105 made of cast iron from being remarkably changed owing to a difference in the thermal expansion coefficients thereof (thermal expansion coefficients of steel and cast iron; 1.1 to 1.5×10⁻⁵), sliding resistance is decreased so that occurrence of problems, such as seizing, can be prevented previously. Accordingly, in this embodiment, from an economical viewpoint, the floating bushing 106 may be preferably made of steel, cast iron and ferrous sintered material, each having thermal expansion coefficients 1.1 to 1.5×10⁻⁵. Especially, when the floating bushing 106 is made of a porous ferrous alloy based sintered material capable of retaining a lubricating oil, adhesion can be prevented when a sufficient amount of lubricating oil will not be supplied at the early stage of operating.

When it is difficult that the sintered sliding material 107 is combined with an inner surface of the floating bushing 106, as shown in FIG. 18B, the sintered sliding material 107′, according to the present invention, is combined with an outer surface of a floating bushing 106′ with which the bearing surface formed on the center housing 105 is slid, and with an outer surface of a turbine shaft 102′ with which an inner surface of the floating bushing 106′ is slid. This combination will provide the same action and effect as this embodiment.

A combining means for combining the sintered sliding material 107 (107′) with the floating bushing 106 (106′) and the turbine shaft 102 (102′) preferably includes caulking, forcing, fitting, clinching, sintering-bonding, infiltrating-bonding, adhesion, bolting, brazing and the like. From a bonding strength viewpoint, sintering-bonding, infiltrating-bonding and brazing are preferred.

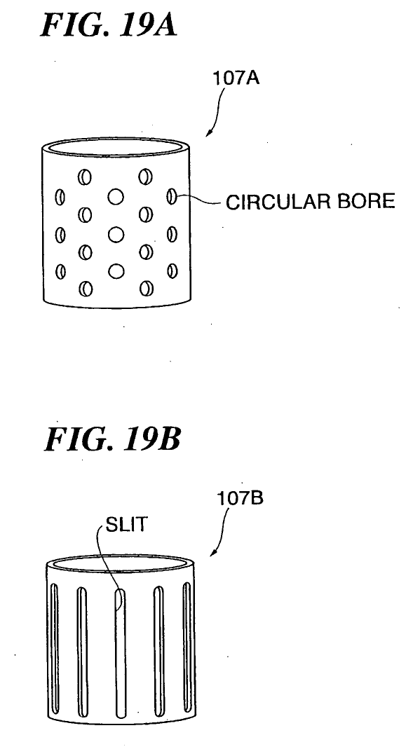

For a current method for increasing yield of the sintered sliding material 107 (107′) and enhancing fluid lubrication with a lubricating oil, the sintered sliding material 107 (107′) formed into a cylindrical shape is formed with predetermined circular holes and slits (as shown in FIG. 19) and then the cylindrical sintered sliding material 107A or 107B is combined with substrates of the floating bushing 106 (106′) and the turbine shaft 102 (102′) so as to form a sliding surface, preferably.

A method for producing a thin cylindrical compact made of Mo principally, in process of producing the sintered sliding material 107 (107′), based on the fact that fine Mo particles are used (described as the later example), includes a method for press-forming a granular powder comprising a raw material powder to which an organic lubricant is added in an amount of 6 to 12 wt %, a method for injection-molding or extrusion-molding a raw material kneaded with an organic lubricant in an amount of 6 to 12 wt % and an amalgamation method for forming Mo powder dispersed in liquid medium.

And, in the aforesaid sintered sliding material 107 (107′), an alloy phase made of Mo principally, such as a Mo metal phase, may be contained for the purpose of improvement in adhesion resistance. Alternatively, a W metal phase, which is expected to demonstrate substantially the same performance as Mo, may be contained.

And, dispersing hard particles excellent in adhesion resistance in the sintered sliding material 107 (107′) in an amount of 0.1 to 5 wt % improves abrasion resistance of the sintered sliding material 107 (107′) remarkably. Accordingly, the sintered sliding material 107 (107′) preferably contains nitride, carbide and carbonitride, such as TiN, CrN, TiC, WC and the like, oxide excellent in thermal shock resistance, such as SiO₂, Al₂O₃, TiO₂ and the like, composite oxide, phosphide such as Fe3P and intermetallic compound such as NiAl, Fe₃Al, TiAl, FeCo, MoFe, Fe₂Ti based intermetallic compounds.

It is possible that a sliding member, according to this embodiment, has a sintered sliding body providing with a sliding bearing performance,

wherein the sintered sliding body is made of a porous sintered compact composed of Mo or Mo alloy, containing one or more elements selected from the group consisting of Cu, Ni, Fe and Co in an amount of 10 wt % or less, wherein the porous sintered compact, having a porosity of 10 to 40% by volume, contains a low-melting metal, which is principally made of one or more elements selected from the group consisting of Pb, Sn, Bi, Zn and Sb and adjusted to have a melting point of 450° C. or less, or an alloy of the low-melting metal filled in pores thereof.

And, it is possible that a sliding member, according to the present invention, has a sintered sliding body providing with a sliding bearing performance,

wherein the sintered sliding body is made of a bronze alloy-Mo based sintered compact composed of bronze alloy phase containing Mo of 5 to 75 wt % and Sn of 5 to 20 wt %, in which the bronze alloy-Mo based sintered compact has a relative density of 90% or more.

It is possible that a sliding member, according to the present invention, has a sintered sliding body providing with a sliding bearing performance,

wherein the sintered sliding body is composed of a bronze alloy-Mo based sintered compact formed such that a Mo powder compact is sintered simultaneously with being infiltrated with a bronze alloy based infiltrant, in which the bronze alloy-Mo based sintered compact contains Mo in an amount of 35 to 75 wt %.

By using the aforesaid sliding members, an available sliding material for a sliding bearing used under a high-speed and high-temperature condition and a high-bearing stress and high-speed sliding condition can be provided.

It is possible that a sliding member according to this embodiment comprises a back metal and a sintered sliding body which is combined with the back metal,

wherein the sintered sliding body is made of a porous sintered compact composed of Mo or Mo alloy, containing one or more elements selected from the group consisting of Cu, Ni, Fe and Co in an amount of 10 wt % or less, wherein the porous sintered compact, having a porosity of 10 to 40% by volume, contains a low-melting metal, which is principally made of one or more elements selected from the group consisting of Pb, Sn, Bi, Zn and Sb and adjusted to have a melting point of 450° C. or less, or an alloy of the low-melting metal filled in pores thereof.

In a sliding member according to this embodiment, the porous sintered compact preferably contains one or more hard particles selected from the group consisting of intermetallic compound, carbide, nitride, oxide and fluoride, which are harder than Mo phase or bronze alloy phase, dispersed therein in a content of 0.2 to 10% by volume. In such a case, the intermetallic compound preferably includes one or more intermetallic compounds selected from the group consisting of MoNi based, MoFe based, MoCo based, FeAl based, NiAl based, NiTi based, TiAl based, based, CoAl based and CoTi based intermerallic compounds and the like. And, the nitride preferably includes one or more nitride selected from the group consisting of TiN, CrN, Si₃N₄ and the like. And, the oxide preferably includes one or more oxides selected from the group consisting of NiO, Cu₂O, CoO, TiO₂, SiO₂, Al₂O₃ and the like. In such a case, in view of damaging property against a counterpart, the hard particles having Vickers hardness of Hv1000 or more are prepared to have a grain size of 10 μm or less, more preferably 5 μm or less.

It is possible that a sliding member according to this embodiment comprises a back metal and a sintered sliding body which is combined with the back metal,

wherein the sintered sliding body is made of a bronze alloy-Mo based sintered compact composed of bronze alloy phase containing Mo of 5 to 75 wt % and Sn of 5 to 20 wt %, in which the bronze alloy-Mo based sintered compact has a relative density of 90% or more.

In the sliding member according to this embodiment, the bronze alloy phase preferably contains one or more elements selected from the group consisting of Ti of 0.2 to 5 wt %, Al of 0.2 to 14 wt %, Pb of 0.2 to 15 wt %, P of 0.1 to 1.5 wt %, Ni of 0.1 to 10 wt %, Co of 0.1 to 5 wt %, Mn of 0.1 to 10 wt % and Si of 0.1 to 3 wt %. And, in order to improve sulfur resistance, one or more elements of Ni of 1 to 5 wt %, Al of 0.5 to 5 wt % and Zn of 1 to 10 wt % are preferably contained.

It is possible that a sliding member according to this embodiment comprises a back metal and a sintered sliding body which is combined with the back metal,

wherein the sintered sliding body is made of a bronze alloy-Mo based sintered compact formed such that a Mo powder compact is sintered simultaneously with being infiltrated with a bronze alloy based infiltrant, in which the bronze alloy-Mo based sintered compact contains Mo in an amount of 35 to 75 wt %.

In a sliding member according to this embodiment, the Mo powder compact may contain either one of a solid lubricant or a hard particles dispersing material mixed thereto in a content of 5 to 60% by volume.

In a sliding member according to this embodiment, it is possible that the bronze alloy-Mo based sintered compact contains one or more hard particles selected from the group consisting of intermetallic compound, carbide, nitride, oxide and fluoride, which are harder than Mo phase or bronze alloy phase, dispersed therein in a content of 0.2 to 10% by volume. In such a case, the intermetallic compound preferably includes one or more intermetallic compounds selected from the group consisting of MoNi based, MoFe based, MoCo based, FeAl based, NiAl based, NiTi based, TiAl based, CoAl based and CoTi based intermerallic compounds. And, the nitride preferably includes one or more nitride selected from the group consisting of TiN, CrN and Si₃N₄. And, the oxide preferably includes one or more oxides selected from the group consisting of NiO, Cu₂O, CoO, TiO₂, SiO₂ and Al₂O₃.

In a sliding member according to this embodiment, a content of Mo is preferably adjusted to be 35 to 65 wt % so that the bronze alloy-Mo based sintered compact will have thermal expansion coefficient of 1.1 to 1.5×10⁻⁵.

According to the sliding members, since the back metal ensures a rigidity of the member, the sintered sliding body is necessary only enough to demonstrate a desirable sliding performance. Accordingly, a desirable sliding performance can be ensured with in low costs.

In a sliding member according to this embodiment, it is possible that the back metal is made of steel, cast iron and Al-Si based alloy, which have thermal expansion coefficient of 1.1 to 1.5×10⁻⁵. By using such back metal, the sliding member can be suitably used for a floating bushing in the turbo charger device, for example.

In a sliding member according to this embodiment, it is possible that the sintered sliding body is combined with the back metal by any method of sintering-bonding, sintering-infiltrating-bonding, brazing, caulking, fitting, forcing, adhesion, bolt tightening and clinching.

Since the bronze alloy-Mo based sintered compact is densified during a Cu-alloy liquid-phase sintering process, the sintered sliding body is easily combined with the back metal by sintering-bonding. And, since at least Ti contained in the bronze alloy-Mo based sintered compact improves sintering-bonding ability remarkably, a cast iron containing inexpensive graphite dispersed therein can be used for the back metal. For example, when the sintered sliding material is sintering-bonded to an inner surface of a cylindrical back metal made of steel or cast iron, at least either one of Al or Si, expanding the bronze alloy-Mo based sintered compact, are preferably added to the bronze alloy-Mo based sintered compact. At the same time, at a last sintering temperature, each addition amount of Ti, Ni, Sn and the like is regulated such that the sintered compact can have a high density (referring to Japanese Patent Publication No.H10-196552 proposed by the inventors).

Accordingly, in a sliding member according to this embodiment, the sintered sliding body is preferably combined with the back metal by sintering-bonding, in which the bronze alloy phase in the sintered sliding body contains at least either one of Ti or Al in an amount of 0.5 wt % or more.

In this embodiment, it is possible that a sliding member has a sliding surface formed by a sintered sliding material made of a porous sintered compact composed of Mo or Mo alloy containing one or more elements selected from the group consisting of Cu, Ni, Fe and Co in an amount of 10 wt % or less, wherein the porous sintered compact, having a porosity of which is principally by volume, contains a low-melting metal made of one or more elements selected from the group consisting of Pb, Sn, Bi, Zn and Sb and adjusted to have a melting point of 450° C. or less or an alloy of the low-melting metal filled in pores thereof.

In the sliding member according to this embodiment, it is possible that the porous sintered compact contains one or more hard selected from the group consisting of intermetallic compound, carbide, nitride, oxide and fluoride, which are harder than Mo phase or bronze alloy phase, dispersed therein in a content of 0.2 to 10% by volume. In such a case, the intermetallic compound preferably includes one or more intermetallic compounds selected from the group consisting of MoNi based, MoFe based, MoCo based, FeAl based, NiAl based, NiTi based, TiAl based, CoAl based and CoTi based intermerallic compounds. And, the nitride preferably includes one or more nitride selected from the group consisting of TiN, CrN and Si₃N₄. And, the oxide preferably includes one or more oxides selected from the group consisting of NiO, Cu₂O, CoO, TiO₂, SiO₂ and Al₂O₃.

A sliding member according to the present invention has a sliding surface formed by a sintered sliding material made of a bronze alloy-Mo based sintered compact composed of a bronze alloy phase, containing Mo of 5 to 75 wt % and Sn of 5 to 20 wt %, in which the bronze alloy-Mo based sintered compact has a relative density of 90% or more.

In a sliding member according to the present invention, the bronze alloy phase preferably contains one or more elements selected from the group consisting of Ti of 0.2 to 5 wt %, Al of 0.2 to 14 wt %, Pb of 0.2 to 15 wt %, P of 0.1 to 1.5 wt %, Ni of 0.1 to 10 wt %, Co of 0.1 to 5 wt %, Mn of 0.1 to 10 wt % and Si of 0.1 to 3 wt %.

A sliding member according to the present invention may have a sliding surface formed by a sintered sliding material made of a bronze alloy-Mo based sintered compact is formed such that a Mo powder compact is sintered simultaneously with being and infiltrated with a bronze alloy based infiltrant, in which the bronze alloy-Mo based sintered compact contains Mo of 35 to 75 wt %.

In a sliding member according to the present invention, it is possible that the Mo powder compact contains at least either one of a solid lubricant or a hard particles dispersing material mixed thereto in a content of 5 to 60% by volume.

In a sliding member according to the present invention, it is possible that the bronze alloy-Mo based sintered compact contains one or more hard particles selected from the group consisting of intermetallic compound, carbide, nitride, oxide and fluoride, which are harder than Mo phase or bronze alloy phase, dispersed therein in a content of 0.2 to 10% by volume. In such a case, the intermetallic compound preferably includes one or more intermetallic compounds selected from the group consisting, of MoNi based, MoFe based, MoCo based, FeAl based, NiAl based, NiTi based, TiAl based, CoAl based and CoTi based intermerallic compounds. And, the nitride preferably includes one or more nitride selected from the group consisting of TiN, CrN and Si₃N₄. And, the oxide preferably includes one or more oxides selected from the group consisting of NiO, Cu₂O, CoO, TiO₂, SiO₂ and Al₂O₃.

In a sliding member according to the present invention, a content of Mo is preferably regulated to 35 to 65 wt % so that the bronze alloy-Mo based sintered compact will be prepared to have thermal expansion coefficient of 1.1 to 1.5×10⁻⁵.

Using the aforesaid sliding members can provide a sliding member having excellent conformability during sliding under a high-bearing stress and high-speed sliding condition as well as excellent seizing resistance and abrasion resistance.

And, the aforesaid sliding member according to this embodiment may be a floating bushing or a turbine used for a turbo charger device.

And, a turbo charger device according to this embodiment may be equipped with at least one of the aforesaid sliding members.

According to this embodiment, a turbo charger device excellent in seizing resistance and abrasion resistance can be provided.

### Embodiment 4

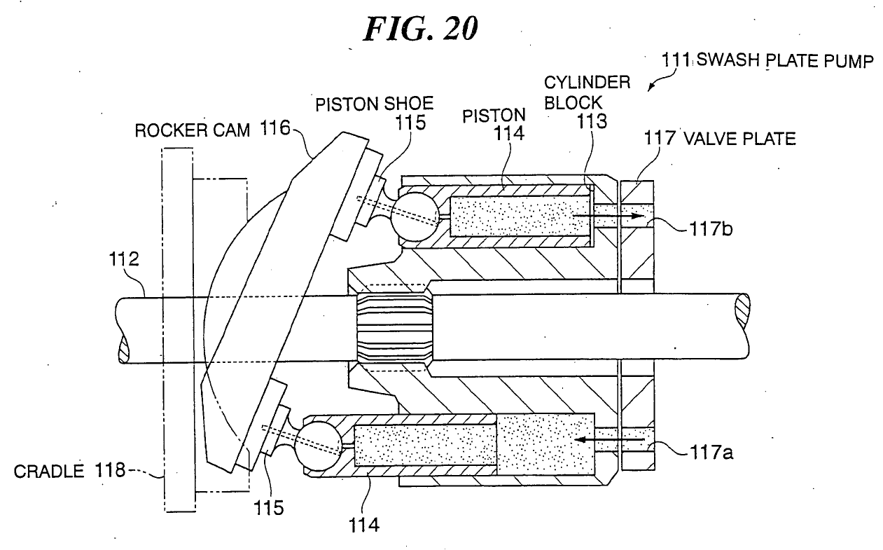

FIG. 20 is a view schematically showing a principal part of a swash plate type hydraulic piston

The swash plate type hydraulic piston pump 111, according to this embodiment, is provided with a drive shaft 112 and a cylinder block 113 on an axis. And, the swash plate type hydraulic piston pump 111 is provided with a piston shoe 115 having a spherical head fitted into one end of a piston 114 which is rotated together with the cylinder block 113. Sliding the piston shoe 115 with respect to a rocker cam 116 disposed at an angle to the drive shaft 112 causes the piston 114 to be reciprocated in the cylinder block 113. This causes an oil sucked via an inlet port 117a of a valve plate 117 to be compressed and to be discharged from an outlet port 117b of the valve plate 117. The angle of the rocker cam 116 is varied by rotating along a sliding surface with a cradle 118 so as to regulate the discharged rate of the oil.

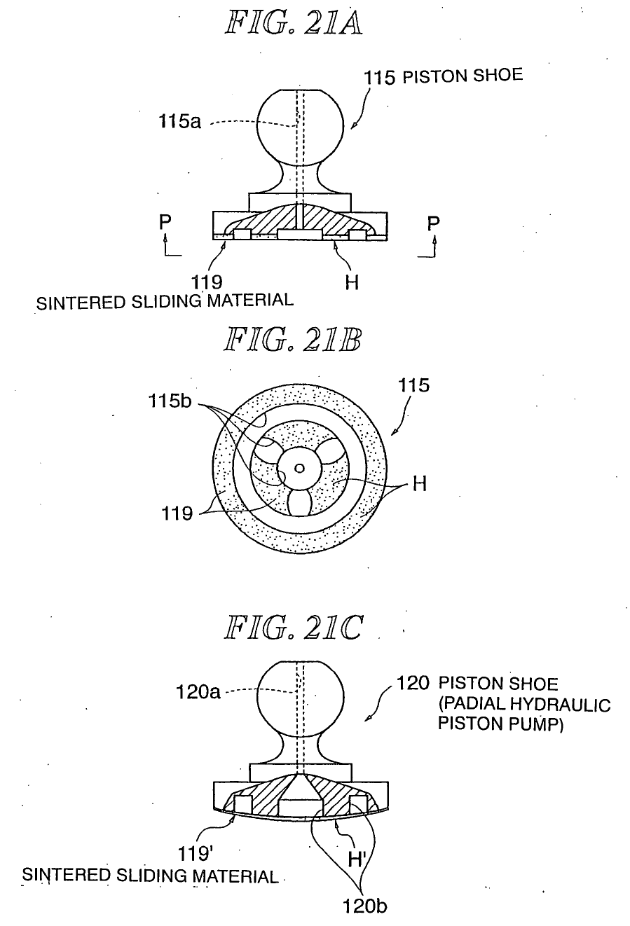

In order to increase an output of the swash plate type hydraulic piston pump 111, it is necessary to increase a hydraulic pressure and an output flow. For this purpose, it becomes important to improve sliding ability between the piston shoe 115 and the rocker cam 116 and increase the angle between the rocker cam 116 and the piston 114 so as to increase the discharged rate of the compressed oil. Accordingly, in this embodiment, as shown in FIGS. 21A and 21B, the piston shoe 115 is made to have a sliding surface H formed such that a sintered material 119, according to the present invention, is combined with a substrate of the piston shoe 115. Thus, the swash plate type hydraulic piston pump 111 can operate with a high-output. In these figures, an oil supplying channel 115a (120a) and an oil lubricating groove 115b (120b) are shown.

In a case of a radial hydraulic piston pump (not shown) having different type from the swash plate type hydraulic piston pump 111 according to this embodiment, combining a sintered sliding material, according to the present invention, with a sliding surface H′ (as shown in FIG. 21C) of the piston shoe 120, a sliding surface of a cam ring (not shown) which is slid with respect to the piston shoe 120 and a sliding surface of a cylinder block and a pintle, which are slid each other as with each other, can provide the radial hydraulic piston pump with a high output. According to the present invention, a swash plate type hydraulic piston motor and a radial hydraulic piston motor, not shown, each having the same structure as the swash plate type hydraulic piston pump and the radial hydraulic piston pump, according to this embodiment, can have the same action and effects of the present invention.

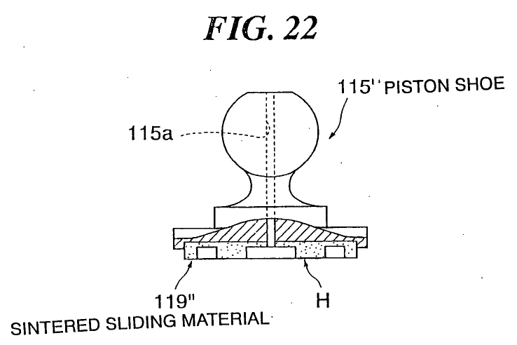

This embodiment shows the piston shoe 115 in which the sintering material 119, according to the present invention, is combined with a substrate of the piston shoe 115 by sintering-bonding or infiltrating-bonding, but is not limited thereto. For example, the piston shoe 115′ may be formed such that a sintering material 119″ according to the present invention is forced and fitted into the substrate of the piston shoe, as shown in FIG. 22.

### Embodiment 5

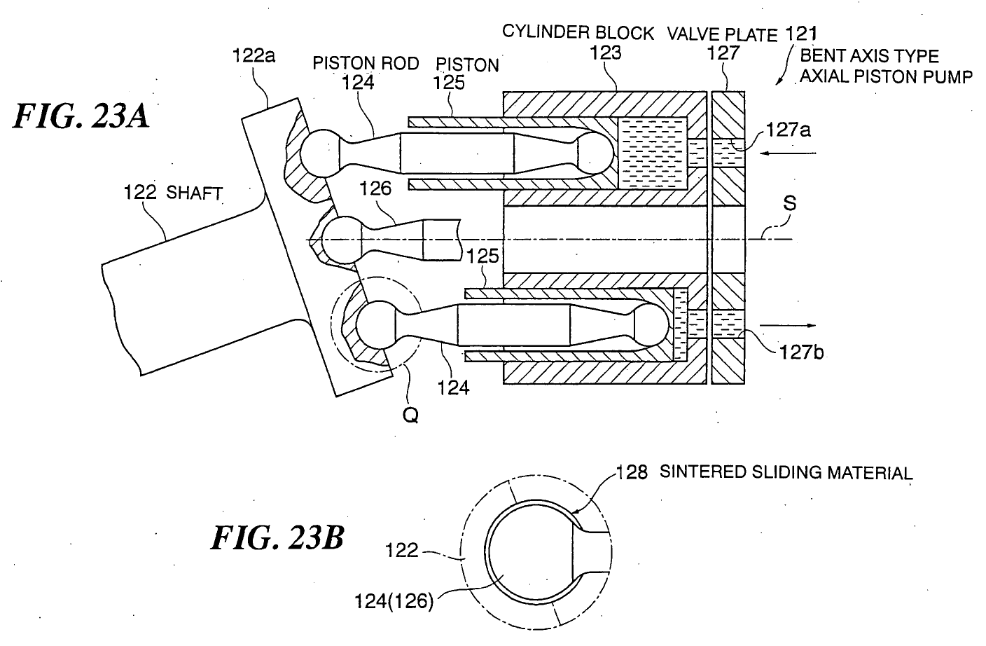

FIG. 23A is a view schematically showing a principal part of a bent axis type hydraulic piston pump and FIG. 23B is an enlarged view showing a Q part of FIG. 23A.

The bent axis type hydraulic piston pump 121, according to the present invention, is provided with a drive shaft 122 and a cylinder block 123 disposed at an angle to the drive shaft 122. And, a piston rod 124 has a spherical head fitted into the spherical concave portion formed on a plate-shaped end 122a of the drive shaft 122. Driving the drive shaft 122 rotates the cylinder block 123 around an axis S of a center shaft 126 via the piston rod 124 and a piston 125 fitted onto the piston rod 124. This causes the piston 125 to be reciprocated in the cylinder block 123, resulting in that an oil sucked via an inlet port 127a of a valve plate 127 is compressed and discharged from an outlet port 127b of the valve plate 127.

In this embodiment, a sliding surface of each of the spherical portions of the piston rod 124 and the center shaft 126 slid at a very slow sliding speed of 0.1 m/sec or less. Such slow sliding speed may cause a boundary lubricating condition and therefore abnormal noises are often generated. Accordingly, in this embodiment, each of the spherical portions of the piston rod 124 and the center shaft 126 is made to have a sliding surface to which a sintered sliding material 128, in the present invention, is sintering-bonded or infiltrating-bonding (as shown in FIG. 23B). This sliding surface can prevent generation of such abnormal noises. In addition, generation of such abnormal noises can be also prevented by combining a sintered sliding material 128 in the present invention with the spherical concave portion of the plate-shaped end 122a of the drive shaft 122, as with this embodiment.

A sliding member according to the present invention may be a aforesaid sliding member including a cylinder block, a valve plate, a rocker cam, a cradle, a piston, a piston shoe, a cam ring, a pintle, a piston rod and a drive shaft, which are used for a hydraulic piston pump or a hydraulic piston motor.

According to the present invention, a sliding member having excellent conformability during sliding under a high-bearing stress and high-speed sliding condition as well as excellent seizing resistance and abrasion resistance can be provided.

A hydraulic piston pump or a hydraulic piston motor according to the present invention may have at least one member of the aforesaid sliding member or a sliding member according to this embodiment.

According to this embodiment, a high-output, high-speed and compact hydraulic piston pump and hydraulic piston motor can be provided.

### EXAMPLE 3

Next, the preferred embodiments of the present invention will be described in detail with reference to accompanying drawings.

(Producing Method of Sintered Sliding Material) In this example, a Mo (1) powder (an average grain size of 0.8 μm) and a Mo (2) powder (an average grain size of 4.7 μm) to which a paraffin wax of 3 wt % was mixed were formed at a pressure of 2 ton/cm² into a cylinder with an inner diameter of 46 mm and a height of 50 mm. Then, the compacts thus obtained were sintered at 950 to 1250° C. for 1 hour and then cooled with N₂ gas.

The compact (density; 4.65 gr/cm³) formed by the fundamental Mo (1) powder shows remarkable contractility at 950° C. and therefore demonstrates sintering ability. And, at each of 1100° C., 1150° C. and 1200° C., while the sintering ability is saturated, contractility can be kept high as a contraction percentage of 14.6%, in which case the compact has an increased relative density of 74% (porosity of 41%). And, the compact (density; 5.82 gr/cm³) formed by the Mo (2) powder shows contractility of contraction percentage of 4.5% and therefore sufficient sintering ability.

And, it is found that each of the compact formed by the Mo (1) powder (hereinafter referred to as the Mo (1) compact) and the compact formed by the Mo (2) powder (hereinafter referred to as the Mo (2) compact) becomes a high-strength porous material having a relative density of about 66 to 74% and a porosity of about 24 to 34% by volume.

By the way, since a conventionally Cu based or Fe based sintered oil-retaining bearing utilizes discharge pores of Sn and Cu as pores, the diameter of the pore becomes large of 10 to 40 μm. The large size pore has an advantage for preventing early occlusion of the pore, however, has disadvantages described below: 1) a hydraulic pressure applied to a sliding surface is easily released, whereby it becomes difficult to form a lubricant oil film under a boundary lubricating condition; 2) a pumping action of a lubricating oil on a sliding surface becomes small whereby the lubricating oil is flowed out remarkably through the pores; and 3) a lubricating oil is unevenly distributed on a sliding surface owing to gravity, whereby seizing owing to an insufficient lubricating oil occurs early depending on a direction in which a load is applied.

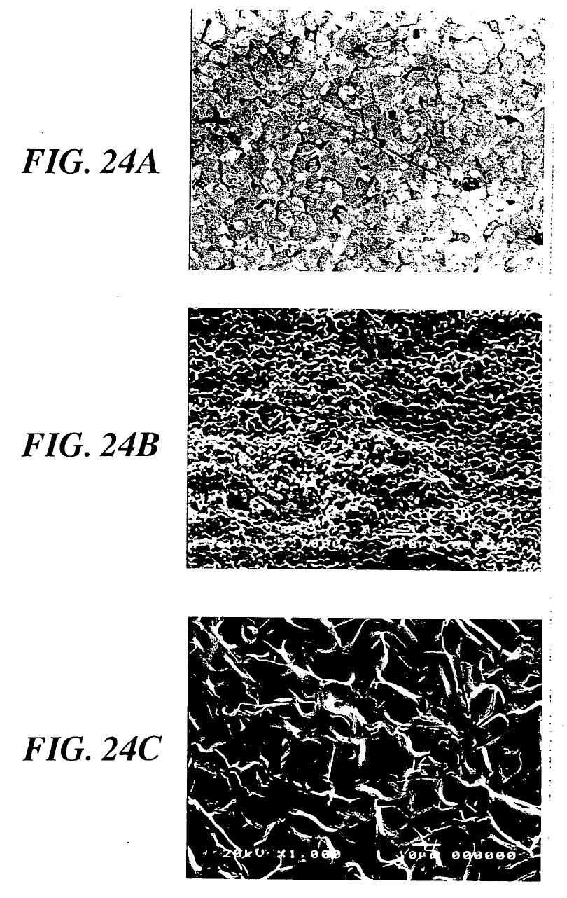

On the contrary, the Mo (1) sintered compact according to this example has fine pores having an average diameter of 0.3 μm or less distributed delicately and communicated each other to form a skeleton structure. This is obviously shown by a photograph showing a cross-sectional structure of the Mo (1) compact sintered at 1185° C. shown in FIG. 24A and a photograph showing a broke surface thereof shown in FIG. 24B. Accordingly, the Mo (1) sintered compact has increased permeating force so that a large amount of lubricating oil can be retained therein and also an amount of the lubricating oil flowed out from the sintered compact during sliding can be kept as small as possible. Accordingly, the aforesaid problem of the conventional Cu based or a Fe based sintered oil retaining bearing can be solved essentially. And, since the Mo (1) sintered compact contains Cu alloy phases distributed therein very uniformly, a high-strength sintered sliding material can be obtained.

In general, a sintered compact made of Mo powder is sintered at 2300 to 2500° C. in hydrogen gas stream, in which case the sintered compact has a density of 9.2 to 9.5 gr/cm³ (a relative density of 90 to 93% and coefficient of contraction of 17.5 to 20%). And then, the sintered compact is hot-worked so as to have a higher density. In addition, the Mo powder compact is hardly sintered at a pre-sintering temperature of 1150° C. and sintered at a sintering temperature of 1300° C. to have a contractility of 2 to 4%. As just described, the Mo powder might be a material hard to be sintered.

On the contrary, in this example, vacuum sintering at 0.01 to 1 torr is performed so as to produce a liquid phase of a low-melting oxide (for example, MoO₃ (melting point; 795° C., boiling point; 795° C.) formed on surfaces of a raw powder for the purpose of promoting sintering. This phenomenon is obviously shown by a photograph of FIG. 24C. The photograph shows that portions, in which sintering is partially promoted in clusters by formation of liquid phases of a low-melting oxide, are scattered and cracks occurs partially in the portions, where the sintering is promoted, at a cooling process. Accordingly, a positive addition of a Mo low-melting oxide, such as MoO₃, to a Mo powder improves sintering ability of a liquid phase. And, by moving a sintering temperature to higher, the low-melting Mo oxide can be reduced or oxygen of the oxide can be volatized and discharged, whereby a high-density Mo sintered compact can be obtained. And, also by adjusting oxygen potential during sintering, a high-density Mo sintered compact can be obtained.

In exchange for MoO₃, which is an example of the low-melting Mo oxide, it is preferable to add oxide (NiO, CoO, FeO, Cuo and the like) of Ni, Fe, Cu, Co, Sn and the like, which are easy to be reduced by vacuum sintering, as an oxygen source for promoting sintering ability of a Mo powder. In such a case, in view of the fact that a conventional liquid phase is sintered to be completely densified when oxide of 10% by volume is added, an addition amount of oxygen is set as much as about 0.1 to 3.0 wt %.

In the No.A1 sintered compact and the No.A2 sintered compact, Young's module of each compact is decreased to about 30 to 50% of Young's module 30000 kgf/mm² of Mo owing to pores contained in each sintered compact at a constant rate, whereby [symbol] like an Cu based ingot material can be achieved. And, the No.A1 sintered compact has Vickers hardness of Hv=92 (at 1150° C.) and the No.A2 sintered compact has Vickers hardness of Hv=66 (at 1150° C.). This result shows that each of the sintered compacts has hardness excellent in conformability as a sliding material. And, the Mo (1) sintered compact having a finer structure than the Mo (2) sintered compact has higher hardness and higher strength than the Mo (2) sintered compact. However, the Mo (2) sintered compact, slightly inferior in hardness and strength to the Mo (1) sintered compact, has sufficient radial crushing strength (15 kgf/mm² or more, tensile strength of about 7 kgf/mm² or more) of a conventional oil retaining bearing. Accordingly, infiltrating the Mo sintered compact with a low-melting alloy filled into the pores can ensure that the low-melting alloy (such as Pb) is supplied to a sliding surface for lubricating under a high-speed and high-temperature sliding condition such as a turbo charger operating condition. And, the small sized pores can provide well liquid lubricating property to the sintered sliding material. In order to improve infiltrating ability of the aforesaid low-melting metal alloy, it is necessary to contain at least either one or more groups, in which one group includes one or more elements selected from group consisting of Ti, Mg, Te, Ca, Ba and Se, which are excellent in affinity with Pb and Mo, and the other group includes one or more elements selected from the group consisting of Cu, Ni, Co and Al, which are excellent in solid solubility with Pb and also affinity with Mo. And, as a infiltrating method, a method in which the low-melting metal is placed on the Mo sintered compact and then the Mo sintered compact is heated in a vacuum, reduction or neutral atmosphere at 450° C. or more is preferred. However, a method in which the Mo sintered compact is immersed in a low-melting alloy solution of 450° C. or more and then infiltrated therewith while applying pressure thereto is more preferred from the viewpoints for ensuring infiltrating ability. And, the low-melting alloy material has strength of several kgf/mm² at a room temperature so as to contribute to strengthen the sintered sliding material.

In this example, the Mo (1) powder was sintered by infiltrating-sintering in such a manner that the Mo (1) compact, on which a compact of Cu-10 wt % Sn (infiltrant 1) was placed thereon, was sintered at 1000 to 1200° C. simultaneously with being infiltrated therewith. This method could produce a high-density bronze alloy-Mo based infiltrating-sintered compact having no pores. And, by the aforesaid infiltrating-sintering method using a compact formed by Cu-20 wt % Sn (infiltrant 2) and the Mo (1) powder compact, a bronze alloy-Mo based infiltrating-sintered compact was produced. In addition, two kinds of bronze alloy-Mo based infiltrating sintered compact were produced by the infiltrating sintering method using the infiltrant 1 compact and the Mo (2) powder compact and using the infiltrant 2 and the Mo (2) powder compact. Here, each infiltrant compact was formed such that a mixed powder consisting of electrolytic Cu powder (CE15), Sn atomized powder under #250 and organic lubricant was formed at a pressure of 4 ton/cm² into the same cylindrical shape and the same infiltrated amount as the Mo (1) and Mo (2) powder compacts by adjusting the height.

A infiltrating sintering at 1150° C. using the infiltrant 2, according to a producing method of a Mo based infiltrating-sintered compact using the infiltrating sintering manner, allows a density of the No.A1 compact to increase from 4.65 gh/cm³ (relative density; about 46%) to 9.31 gr/cm³ after the infiltrating-sintering. And, the Mo based infiltrated sintered compact is hardened to have hardness of Hv325.

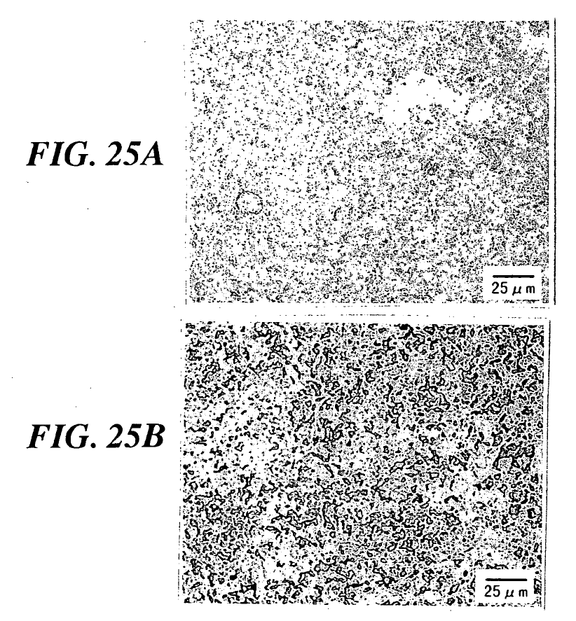

Each of the bronze alloy-Mo based infiltrating sintered compacts has no pores so as to be strengthened. This is obviously shown in a photograph, shown in FIG. 25A showing a structure of the bronze alloy-Mo based infiltrating sintered compact produced by the Mo (1) powder compact and the infiltrant 2, and a photograph, shown in FIG. 25B showing a structure of the bronze alloy-Mo based infiltrating sintered compact produced by the Mo (2) powder compact and the infiltrant 2. And, the bronze alloy-Mo based infiltrating sintered compact, shown in FIG. 25A, produced using finer Mo (1) powder (an average grain size of 0.8 μm) has a finely and uniformly structure more than the bronze ally-Mo based infiltrating-sintered compact, shown in FIG. 25B, produced using the Mo (2) powder (an average grain size of 4.7 μm) coarser than the Mo (1) powder. And, the bronze alloy-Mo based infiltrating-sintered compact, shown in FIG. 25A, is superior in hardness, strength and sliding performance than the bronze alloy-Mo based infiltrating-sintered compact, shown in FIG. 25B.

As a result of examining an effect of infiltrating sintering on contraction percentage of each of the Mo (1) powder compact and the Mo (2) powder compact, while the Mo (1) powder compact is infiltrating sintered to have a contraction percentage of 10% at 1000° C., 8.1% at 1150° C. and 7.3% at 1200° C., the Mo (2) powder compact is infiltrating-sintered to have a small contraction percentage as 3.7% or less. And, the difference in the contraction percentage mostly affects on sintering ability of a Mo powder, which will become a base of the sintered compact. Especially, a bronze alloy containing a large amount of Sn is preferably infiltrating-sintered at a temperature under 1150° C. in view of evaporation of Sn. And, it is found that a infiltrating-sintering method according to the present invention is very suitable for a method of producing a high-density sintered sliding material composed of Mo phase in a content of 35 to 70% by volume and a residue made of Cu or Cu alloy phase.

In addition, a powder compact of Mo powder (the Mo (1) powder or the Mo (2) powder), to which hard particles (for example, TiC, TiN, TiCN, W, CrN, ferromolybdenum (for example, 50 to 70 wt % Mo—Fe) and Si₃N₄) and solid lubricant (for example, CaF₂ and graphite), improving abrasion resistance, were previously added, was infiltrating-sintered in the aforesaid manner, resulting in producing a high-strength and oilless sintered sliding material excellent in lubricating property. Especially, using fine Mo powder can achieve a sintered sliding material excellent in sliding performance with keeping its strength, even if a solid lubricant larger and softer than Mo particle is added in a large amount (referring to Japanese Patent No.3214862 proposed by the inventors). Accordingly, when at least one of a connecting pin and a bearing bushing of a connecting device of a construction machine, such as a hydraulic excavator, is made to be combined with a Mo based or a Mo—Cu (Cu alloy) based sintered sliding material containing solid lubricant, the construction machine can be operated with a long lubricating interval or without lubricating. Here, the solid lubricant preferably has an grain size about 3 times, more preferably 5 times an grain size of the Mo powder, which is introduced from geometrical relationship shown in FIG. 24A and FIG. 24B.

In this example, using electrolytic Cu powder (CE15, manufactured by FUKUDA METAL FOIL & POWDER Co., LTD.), the Mo (2) powder, Sn powder, TiH powder, Pb powder, 27 wt % Fe—P under #350, various mixed powder were prepared to have compositions shown in Table 5 and contain Mo in an amount of 0, 3, 5, 10, 15 and 25 wt %. And, each mixed powder was formed and then sintered at 850 to 950° C. Then, each sintered compact was examined in liquid-phase sintering ability. In such a case, TiH, Pb and 27 wt % Fe—P were added for the purpose of improvement in wettability with Mo powder.

TABLE 5
COMPOSITIONS(WT %) AND TEST RESULT

| | | | | | | | | | SEIZING | |
|---|---|---|---|---|---|---|---|---|---|---|
| | | | | | | | | 865° C, | BEARING STRESS | |
| | Cu(CE15) | Mo(2) | Sn | Cu20Sn | TiH | Pb | Fe27P | DENSITY(gr/cm³) | (kgf/cm²) | COMMENT |
| B1 | Bal. | 0 | 6 | 28 | 0.7 | 8 | 1 | 8.5 | 300 | |
| B2 | Bal. | 5 | 6 | 28 | | 8 | | 7.65 | 350 | FORMING |
| B3 | Bal. | 3 | 6 | 28 | 0.7 | 8 | 1 | 8.38 | 350 | |
| B4 | Bal. | 5 | 6 | 28 | 0.7 | 8 | 1 | 8.6 | 450 | |
| B5 | Bal. | 10 | 6 | 28 | 0.7 | 8 | 1 | 8.9 | 600 | |
| B6 | Bal. | 15 | 6 | 28 | 0.7 | 8 | 1 | 9.1 | 650 | |
| B7 | Bal. | 25 | 6 | 28 | 0.7 | 8 | 1 | 9.2* | 700 | |
| Mo SPRAYING | | | | | | | | | 650 | |
| C(Mo(2)/Pb-1Ti) | | | | | | | | | 850 | |
| D(Mo(2)/Bi-4Ni) | | | | | | | | | 800 | |
| E(Mo(1)/Cu20Sn) | | | | | | | | | 800 | |
| F(Mo(2)/Cu20Sn) | | | | | | | | | 750 | |
| G(5 wt % GRAPHITE) | | | | | | | | | 800 | |
| LBC4 | | | | | | | | | 250 | ABNORMAL |
| | | | | | | | | | ABRATION | |
| HIGH STRENGTH | | | | | | | | | 350 | |
| BRASS(P31C)** | | | | | | | | | | |

*SINTERING TEMPERATURE 885° C.
**CHUETSU COPPER ALLOY

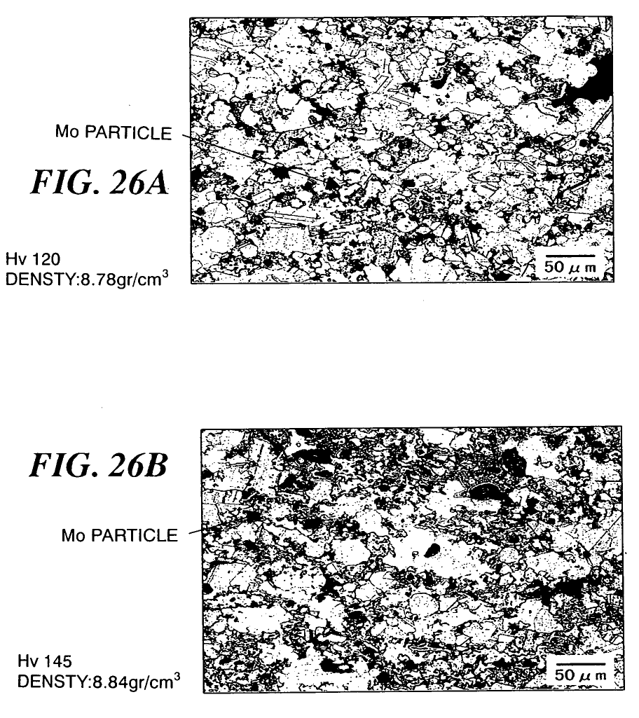

As a result, as shown in the right column of the table 5, improving wettability enables obtaining a high-density bronze alloy-Mo based infiltrating-sintered compact even if a large amount of Mo powder are dispersed therein. FIG. 26A and FIG. 26B are photographs showing sintered structures of No.B4 sintered compact and No.B6 sintered compact, respectively, in table 5. The figures show that both sintered compacts are sintered to have a high density. And, the No.B4 and No B6 sintered compacts, to which Ti and Pb are added for improving wettability at a liquid phase sintering, can be improved in a sintered density (a porosity of the sintered compact) by adjusting a sintering temperature to 865° C. In which case, the sintered compacts has hardness of Hv120, Hv145, respectively, and therefore has sufficient radial crushing strength and tensile strength for a sliding material used under a high bearing stress. In addition, such sliding material is suitably used under a high-speed and light-load sliding condition with being lubricated with an oil.

### EXAMPLE 4

(Constant-Rate Friction and Abrasion Test)

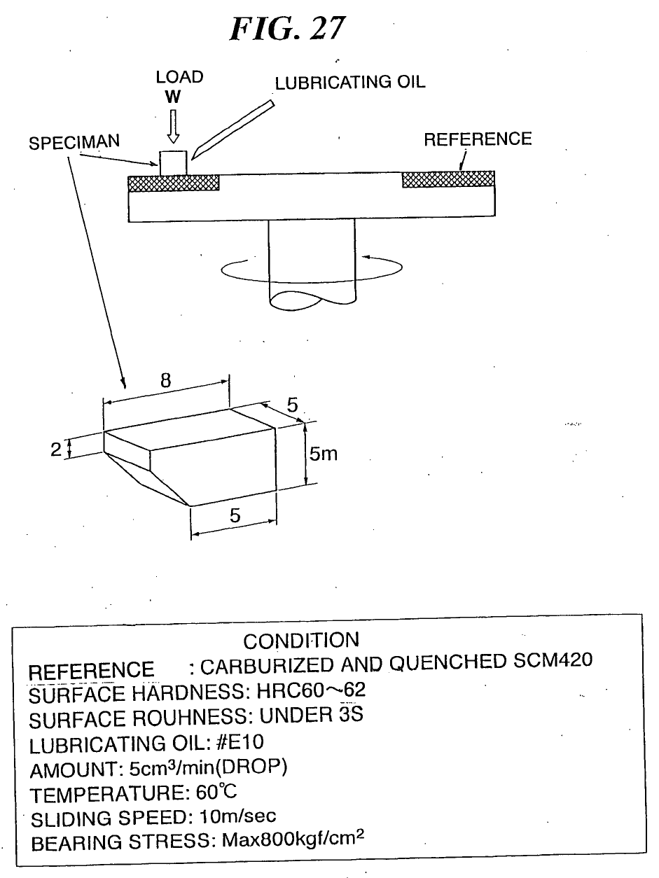

In this example, the bronze alloy-Mo based infiltrating-sintered compacts produced by Example 3 were examined in a critical seizing resistant bearing stress or an abnormal abrasion occurrence bearing stress using a constant-rate friction and abrasion tester shown in FIG. 27. In addition, a sliding material (C) in which the Mo (2) sintered compact was infiltrated at 700° C. with Pb-1 wt % Ti, a sliding material (D) in which the Mo (2) sintered compact was infiltrated at 700° C. with Bi-4 wt % Ti, a sliding material (E) in which the Mo (1) was infiltrated with Cu-20 wt % Sn, a sliding material (F) in which the Mo (2) was infiltrated with Cu-20 wt % Sn and a bushing (G) made such that the Mo (2) matrix containing graphite granulated using water glass having a diameter of 0.1 to 0.3 mm dispersed therein in an amount of 5 wt % (about 30% by volume) was infiltrated with Cu-20 wt % Sn alloy were also prepared for the test. As comparative specimens, a specimen made of a lead bronze ingot sliding material containing Pb in an amount of 15 wt %, a specimen made of a specific high strength brass (PC31) and a specimen (porosity of about 10%) of which a sliding surface was plasma-spray coated with Mo were further prepared. A sliding test was carried out such that a disc made of SCM415 which was carburized and quenched so as to have surface hardness of HRC60 and surface roughness of 3 μm or less was slid with respect to the specimens while the disc being rotated and #10 engine oil heated at 60° C. being dropped on a surface of the specimen at a dropping rate of 5 cm³/mm so as to lubricate the surface. Then, friction coefficient and abrasion amount of each specimen were measured. When seizing or abnormal abrasion did not happen for 2 minutes at a predetermined bearing stress, the bearing stress was increased in increment of 50 kgf/cm² until seizing or abnormal abrasion will occur.

The results are shown in the right column of table 5. As an addition amount of Mo exceeds 5 wt %, critical seizing resistant bearing stress is improved remarkably. In such a case, the lower limit of an addition amount of Mo phase is 5 wt %, more preferably 10%. And, from an economical viewpoint, the upper limit thereof is preferably set at 70 wt % because the bearing stress of the specimen (F) (containing Mo in an amount of 70 wt %) is approached to an excellent critical seizing resistant bearing stress inherent in Mo and then saturated (in addition, Mo can be added in a maximum amount of 90 wt %).

The invention is not be considered limited to what is shown and described in the specification without departing from the scope of the invention.

1. A sintered sliding material comprising a sintered compact, wherein said sintered compact contains Cu or Cu alloy in an amount of 10 to 95 wt % and a residual made of Mo principally and has a relative density of 80% or more.

2. A sintered sliding material according to claim 1, wherein said sintered compact is formed such that a Mo compact is sintered simultaneously with being infiltrated with Cu or Cu alloy, said sintered compact containing Mo in an amount of 35 to 75 wt % and having a porosity of 7% or less by volume.

3. A sintered sliding material according to claim 2, wherein said Mo compact is composed of Mo powder having an average grain size of 10 μm or less, said Mo compact containing a solid lubricant, having an average grain size of 30 μm or more, in a content of 5 to 60% by volume and/or hard particles in a content of 0.2 to 10% by volume.

4. A sintered sliding material according to claim 1, wherein Cu alloy phase in said sintered compact contains Sn in an amount of 5 to 20 wt %.

5. A sintered sliding material according to claim 4, wherein Cu alloy phase in said sintered compact contains one or more elements selected from the group consisting of Ti of 0.2 to 5 wt %, Al of 0.2 to 14 wt %, Pb of 0.2 to 15 wt %, P of 0.1 to 1.5 wt %, Zn of 0.1 to 10 wt %, Ni of 0.1 to 10 wt %, Co of 0.1 to 5 wt %, Mn of 0.1 to 10 wt % and Si of 0.1 to 3 wt %.

6. A sliding member comprising:
a back metal and a sintered sliding body combined with the back metal,
wherein said sintered sliding body is composed of a sintered compact containing Cu or Cu alloy in an amount of 10 to 95 wt % and a residual made of Mo principally, said sintered compact having a relative density of 80% or more.

7. A sliding member according to claim 6, wherein said sintered compact is formed such that a Mo compact is sintered simultaneously with being infiltrated with Cu or Cu alloy, said sintered compact containing Mo in an amount of 35 to 75 wt % and having a porosity of 7% or less by volume.

8. A sliding member according to claim 7, wherein said Mo compact is composed of Mo powder having an average grain size of 10 μm or less, said Mo compact containing a solid lubricant, having an average grain size of 30 μm or more, in a content of 5 to 60% by volume and/or hard particles in a content of 0.2 to 10% by volume.

9. A sliding member according to claim 6, wherein Cu alloy phase in said sintered compact contains Sn in an amount of 5 to 20 wt %.

10. A sliding member according to claim 9, wherein Cu alloy phase in said sintered compact contains one or more elements selected from the group consisting of Ti of 0.2 to 5 wt %, Al of 0.2 to 14 wt %, Pb of 0.2 to 15 wt %, P of 0.1 to 1.5 wt %, Zn of 0.1 to 10 wt %, Ni of 0.1 to 10 wt %, Co of 0.1 to 5 wt %, Mn of 0.1 to 10 wt % and Si of 0.1 to 3 wt %.

11. A sliding member according to claim 6, wherein sliding surfaces of said sintered sliding body are formed with recesses in which any one of a lubricating compound of a lubricating oil and a wax, a lubricating resin, a solid lubricant and a lubricating compound of a solid lubricant and a wax are filled.

12. A sliding member according to claim 6, wherein said back metal is any one of a back metal of a sliding bearing, a substrate of a bearing shaft supporting a rotating body and a substrate of a spherical bushing.

13. A sliding member comprising:
a sintered layer combined with a steel back metal, and,
a sliding layer formed by lining said sintered layer with at least any one of a lubricating compound, a lubricating resin and a solid lubricating composite consisting of a solid lubricant and a resin while being filled therewith,
wherein said sintered layer is combined with said steel back metal in a manner such that a mixed powder of bronze alloy, containing Sn of 5 to 20 wt %, in a content of 10 to 95 wt % and a residual made of Mo principally is dispersed in said steel back metal and sintering-bonded thereto.

14. A sliding member according to claim 13, wherein said sliding member is formed into a cylindrical shape or an approximately cylindrical shape by bending said back metal with said sliding surface layer being inside or outside.

15. A sliding member according to claim 13, wherein said steel back metal is treated such that a surface subjected to said sintering-bonding is plated with Cu or sintering-bonded with a bronze based, a lead bronze based, a Fe—Cu—Sn based or a Fe—Cu—Sn—Pb based sintered material.

16. A sliding member according to claim 13,
wherein said mixed powder is granulated to have an average grain size of 0.05 to 2.0 mm.

17. A sliding member comprising:
a sintered layer combined with a steel back metal,
small pieces of a sintered sliding material, said small pieces being dispersed in said sintered layer, and
a bronze based sintered compact disposed around said small pieces,
wherein said sintered layer is made such that a bronze based, a lead bronze based, a Fe—Cu—Sn based or a Fe—Cu—Sn—Pb based sintered material is sintering-bonded to said steel back metal,
said small pieces are combined with said steel back metal with being enveloped with said bronze based sintered compact, and
said sintered sliding material is composed of a sintered compact containing Cu or Cu alloy in an amount of 10 to 95 wt % and a residue made of Mo principally and having a relative density of 90% or more.

18. A sliding member according to claim 17, wherein said sintered compact is formed such that a Mo compact is sintered simultaneously with being infiltrated with Cu or Cu alloy, said sintered compact containing Mo in an amount of 35 to 75 wt % and having a porosity of 7% or less by volume.

19. A sliding member according to claim 18, said Mo compact is composed of Mo powder having an average grain size of 10 μm or less, said Mo compact containing a solid lubricant, having an average grain size of 30 μm or more, in a content of 5 to 60% by volume and/or hard particles in a content of 0.2 to 10% by volume.

20. A sliding member according to claim 17, wherein Cu alloy phase in said sintered compact contains Sn of 5 to 20 wt % and further one or more elements selected from the group consisting of Ti of 0.2 to 5 wt %, Al of 0.2 to 14 wt %, Pb of 0.2 to 15 wt %, P of 0.1 to 1.5 wt %, Zn of 0.1 to 10 wt %, Ni of 0.1 to 10 wt %, Co of 0.1 to 5 wt %, Mn of 0.1 to 10 wt % and Si of 0.1 to 3 wt %.

21. A connecting device for connecting a pair of components in a rotatable and turnable manner, in which one component is arranged via a bearing axis supported by the other component and a bearing bushing fitted onto the bearing axis, or connecting a pair of components in a rotatable and turnable manner and also receiving a thrust load applied between the components by a thrust bearing, in which one component is arranged via a bearing axis supported by the other component and a bearing bushing fitted onto the bearing axis,
wherein said one or more elements of said bearing axis, said bearing bushing and said thrust bearing are made of a sliding member, and
said sliding member comprises a back metal and a sintered sliding body combined with the back metal,
wherein said sintered sliding body is composed of a sintered compact containing Cu or Cu alloy in an amount of 10 to 95 wt % and a residue made of Mo and having a relative density of 80% or more, and
said back metal is any one of a back metal of a bearing, a substrate of a bearing axis and a substrate of a spherical bushing.

22. A connecting device for connecting a pair of components in a rotatable and turnable manner, in which one component is arranged via a bearing axis supported by the other component and a bearing bushing fitted onto the bearing axis,
wherein said bearing axis is made of a sliding member, and
said bearing bushing is made of a steel pipe, which is not heat-treated for hardening and is formed with necessary lubricating grooves at a sliding surface thereof, and
said sliding member comprises a back metal and a sintered sliding body combined with the back metal,
wherein said sintered sliding body is made of a sintered compact composed of Cu or Cu alloy in an amount of 10 to 95 wt % and a residue made of Mo principally, said sintered compact having a relative density of 80% or more, and
said back metal is a substrate of the bearing axis.

23. A connecting device for connecting a pair of components in a rotatable and turnable manner, in which one component is arranged via a bearing axis supported by the other component and a bearing bushing fitted onto the bearing axis,
wherein said bearing axis is made of a sliding member, and
said bearing bushing is made of a Fe—C based, a Fe—C—Cu based or a Cu—Sn based oil retaining sintered material,
wherein said sliding member comprises a back metal and a sintered sliding body combined with the back metal,
wherein said sintered sliding body is made of a sintered compact composed of Cu or Cu alloy in an amount of 10 to 95 wt % and a residue made of Mo principally, said sintered compact having a relative density of 90% or more, and
said back metal is a substrate of the bearing axis.

24. A connecting device according to claim 21, wherein said sintered compact is formed such that a Mo compact is sintered simultaneously with being infiltrated with Cu or Cu alloy, said sintered compact containing Mo of 35 to 75 wt % and having a porosity of 7% or less by volume.

25. A connecting device according to claim 24, wherein said Mo compact is composed of Mo powder having an average grain size of 10 μm or less, said Mo compact containing a solid lubricant, having an average grain size of 30 μm or more, in a content of 5 to 60% by volume and/or hard particles in a content of 0.2 to 10% by volume.

26. A connecting device according to claim 21, wherein Cu alloy phase in said sintered compact contains Sn of 5 to 20 wt % and further one or more elements selected from the group consisting of Ti of 0.2 to 5 wt %, Al of 0.2 to 14 wt %, Pb of 0.2 to 15 wt %, P of 0.1 to 1.5 wt %, Zn of 0.1 to 10 wt %, Ni of 0.1 to 10 wt %, Co of 0.1 to 5 wt %, Mn of 0.1 to 10 wt % and Si of 0.1 to 3 wt %.

27. A connecting device according to claim 21, wherein said bearing axis is formed with said sintered sliding body at supported portions of said bearing axis by the component.

28. A connecting device according to claim 21, wherein said connecting device is used for any one of connecting means of an operating machine, a track link and a track roller of a crawler vehicle, an equalizer bar suspension supporting a vehicle of a bulldozer and a suspension unit of a dump track.

29. A sintered sliding material comprising a porous sintered material,
wherein said porous sintered material is composed of Mo or Mo alloy containing one or more elements selected from the group consisting of Cu, Ni, Fe and Co in an amount of 10 wt % or less, said porous sintered material, having a porosity of 10 to 40% by volume, containing a lubricating oil or a lubricating compound of a lubricating oil and a wax filled in the pores.

30. A sintered sliding material comprising a porous sintered material,
wherein said porous sintered material is composed of Mo or Mo alloy containing one or more elements selected from the group consisting of Cu, Ni, Fe and Co in an amount of 10 wt % or less, said porous sintered material, having a porosity of 10 to 40% by volume, containing a low-melting metal, which is principally made of one or more elements selected from the group consisting of Pb, Sn, Bi, Zn and Sb and adjusted to have a melting point of 450° C. or less, or an alloy of the low-melting metal filled in the pores.

31. A sintered sliding material according to claim 29, wherein said porous sintered material contains one or more hard particles selected from the group consisting of intermetallic compound, carbide, nitride, oxide and fluoride, which are harder than Mo phase or bronze phase, dispersed therein in a content of 0.2 to 10% by volume.

32. A sintered sliding material according to claim 31, wherein said intermetallic compound includes one or more intermetallic compounds selected from the group consisting of MoNi based, MoFe based, MoCo based, FeAl based, NiAl based, NiTi based, TiAl based, CoAl based and CoTi based intermerallic compounds.

33. A sintered sliding material according to claim 31, wherein said nitride includes one or more nitrides selected from the group consisting of TiN, CrN and Si₃N₄.

34. A sintered sliding material according to claim 31,
wherein said oxide includes one or more oxides selected from the group consisting of NiO, Cu₂O, CoO, TiO₂, SiO₂ and Al₂O₃.

35. A sintered sliding material comprising a bronze alloy-Mo based sintered compact,
wherein said bronze alloy-Mo based sintered compact is composed of a bronze alloy phase containing Mo of 5 to 75 wt % and Sn of 5 to 20 wt %, said bronze alloy-Mo based sintered compact having a relative density of 90% or more.

36. A sintered sliding material according to claim 35, wherein said bronze alloy phase contains one or more elements selected from the group consisting of Ti of 0.2 to 5 wt %, Al of 0.2 to 14 wt %, Pb of 0.2 to 15 wt %, P of 0.1 to 1.5 wt %, Ni of 0.1 to 10 wt %, Co of 0.1 to 5 wt %, Mn of 0.1 to 10 wt % and Si of 0.1 to 3 wt %.

37. A sintered sliding material comprising a bronze alloy-Mo based sintered compact, wherein said bronze alloy-Mo based sintered compact is formed such that a Mo powder compact is sintered simultaneously with being infiltrated with bronze alloy based infiltrant, said bronze alloy-Mo based sintered compact containing Mo in an amount of 35 to 75 wt %.

38. A sintered sliding material according to claim 37,
wherein said Mo powder compact contains at least either one of a solid lubricant or a hard particle dispersing material in a content of 5 to 60% by volume mixed therewith.

39. A sintered sliding material according to claim 35, wherein said bronze alloy-Mo based sintered compact contains one or more hard particles selected from the group consisting of intermetallic compound, carbide, nitride, oxide and fluoride, which are harder than Mo phase or bronze phase, dispersed therein in a content of 0.2 to 10% by volume.

40. A sintered sliding material according to claim 35, wherein a content of Mo is regulated to 35 to 65 wt % so that said bronze alloy-Mo based sintered compact has a thermal expansion coefficient of 1.1 to 1.5×10⁻⁵.

41. A sliding member having a sintered sliding body,
wherein said sintered sliding body is made of a porous sintered compact composed of Mo or Mo alloy containing one or more elements selected from the group consisting of Cu, Ni, Fe and Co in an amount of 10 wt % or less, said porous sintered compact, having a porosity of 10 to 40% by volume, containing a low-melting metal, which is principally made of one or more elements selected from the group consisting of Pb, Sn, Bi, Zn and Sb and adjusted to have a melting point of 450° C. or less, or an alloy of the low-melting metal filled in pores thereof.

42. A sliding member having a sintered sliding body,
wherein said sintered sliding body is made of a bronze alloy-Mo based sintered compact composed of bronze alloy phase containing Mo of 5 to 75 wt % and Sn of 5 to 20 wt %, said bronze alloy-Mo based sintered compact having a relative density of 90% or more.

43. A sliding member having a sintered sliding body,
wherein said sintered sliding body is composed of a bronze alloy-Mo based sintered compact formed such that a Mo powder compact is sintered simultaneously with being infiltrated with a bronze alloy based infiltrant, said bronze alloy-Mo based sintered compact containing Mo in an amount of 35 to 75 wt %.

44. A sliding member comprising a back metal and a sintered sliding body which is combined with the back metal,
wherein said sintered sliding body is made of a porous sintered compact composed of Mo or Mo alloy containing one or more elements selected from the group consisting of Cu, Ni, Fe and Co in an amount of 10 wt % or less, said porous sintered compact, having a porosity of 10 to 40% by volume, containing a low-melting metal, which is principally made of one or more elements selected from the group consisting of Pb, Sn, Bi, Zn and Sb and adjusted to have a melting point of 450° C. or less, or an alloy of the low-melting metal filled in pores thereof.

45. A sliding member according to claim 41,
wherein said porous sintered compact contains one or more hard particles selected from the group consisting of intermetallic compound, carbide, nitride, oxide and fluoride, which are harder than Mo phase or bronze alloy phase, dispersed therein in a content of 0.2 to 10% by volume.

46. A sliding member comprising a back metal and a sintered sliding body which is combined with the back metal,
wherein said sintered sliding body is made of a bronze alloy-Mo based sintered compact composed of bronze alloy phase containing Mo of 5 to 75 wt % and Sn of 5 to 20 wt %, said bronze alloy-Mo based sintered compact having a relative density of 90% or more.

47. A sliding member according to claim 42,
wherein said bronze alloy phase contains one or more elements selected from the group consisting of Ti of 0.2 to 5 wt %, Al of 0.2 to 14 wt %, Pb of 0.2 to 15 wt %, P of 0.1 to 1.5 wt %, Ni of 0.1 to 10 wt %, Co of 0.1 to 5 wt %, Mn of 0.1 to 10 wt % and Si of 0.1 to 3 wt %.

48. A sliding member comprising a back metal and a sintered sliding body which is combined with the back metal,
wherein said sintered sliding body is made of a bronze alloy-Mo based sintered compact formed such that a Mo powder compact is sintered simultaneously with being infiltrated with a bronze alloy based infiltrant, said bronze alloy-Mo based sintered compact containing Mo in an amount of 35 to 75 wt %.

49. A sliding member according to claim 43,
wherein said Mo powder compact contains either one of a solid lubricant or a hard particles dispersing material mixed thereto in a content of 5 to 60% by volume.

50. A sliding member according to claim 42,
wherein said bronze alloy-Mo based sintered compact contains one or more hard particles selected from the group consisting of intermetallic compound, carbide, nitride, oxide and fluoride, which are harder than Mo phase or bronze alloy phase, dispersed therein in a content of 0.2 to 10% by volume.

51. A sliding member according to claim 42,
wherein a content of Mo is adjusted to be 35 to 65 wt % so that said bronze alloy-Mo based sintered compact has thermal expansion coefficient of 1.1 to 1.5×10⁻⁵.

52. A sliding member according to claim 44, wherein said back metal is made of steel, cast iron and Al—Si based alloy, each having thermal expansion coefficient of 1.1 to 1.5×10⁻⁵.

53. A sliding member according to claim 6,
wherein said sintered sliding body is combined with said back metal by any method of sintering-bonding, sintering-infiltrating-bonding, brazing, caulking, fitting, forcing, adhesion, bolt tightening and clinching.

54. A sliding member according to claim 6,
wherein said sintered sliding body is combined with said back metal by sintering-bonding, said bronze alloy phase in said sintered sliding body containing at least either one of Ti or Al in an amount of 0.5 wt % or more.

55. A turbo charger device equipped with a sliding member according to claim 41.

56. A hydraulic piston pump or a hydraulic piston motor equipped with a sliding member according to claim 41.
